(19) United States
(12) Patent Application Publication
(10) Pub. No.: US 2015/0181152 A1
(43) Pub. Date: Jun. 25, 2015

(54) SYSTEMS, DEVICES AND METHODS FOR INTERACTIVE AND BIDIRECTIONAL MESSAGE OVERLAY ON A COMMUNICATIONS SIGNAL

(71) Applicant: Skylight Healthcare Corporation, San Diego, CA (US)

(72) Inventors: Rich Holbrook, San Diego, CA (US); Christian Loewenstein, San Diego, CA (US); Rajkumar Farkiya, San Diego, CA (US)

(21) Appl. No.: 14/577,736

(22) Filed: Dec. 19, 2014

Related U.S. Application Data
(60) Provisional application No. 61/919,626, filed on Dec. 20, 2013.

(51) Int. Cl. H04N 5/445; G06T 11/60; G06T 11/00

(52) U.S. Cl. CPC H04N 5/44504; G06T 11/001; G06T 11/60; H04N 5/44582

(57) ABSTRACT

Systems and methods are disclosed for overlaying interactive and bidirectional messages on a communications device via a communications signal. The system and related methods allow for such communications between remote locations where one of the locations has a communications device, such as a television. Data from a sensor, such as a medical device, or input from a user, such as a patient, may be communicated between the locations. The overlaid messages may be displayed on the communications device display, such as a television or computer.

### BACKGROUND

1. Field of the Development

The present disclosure relates generally to systems and methods for overlaying messages on communications signals. Specifically, features adapted for overlaying bi-directional and interactive communications onto an active communications signal, for example a television signal, are disclosed.

2. Description of the Related Art

Communication plays a key role in many contexts. Typically, the higher quality the communications are between two parties, the better the outcome in their respective discussions or situations. Higher quality communications may be achieved in a variety of ways. For example, the clarity of the communication itself is tremendously important. Also critical is the frequency of the communications and the ability to timely and responsively receive and transmit communications among and between the parties. While a single, unidirectional, clearly transmitted communication may be very helpful, still more helpful is the capability to receive feedback and to have a dialogue or exchange between the communicating parties in real-time. Part of what allows for more frequent communications and a fruitful exchange is the ability to reach the parties, to make sure the message is getting across to the others, and to be able to reply in real-time.

The modern world is full of means of communications that allow for exchange and delivery of messages to others. However, not all of them come with the same level of assurance of delivery or convenience of use along with the ability to reply in real-time. For instance, while email may be sent to anyone with an email account, the receiver requires access to that email account to get the message, and that typically requires an internet connection. Further, the emails can be easily ignored or disregarded, and people aren't always monitoring their email, making real-time feedback less likely. Another example is the cell phone. While the cell phone allows for real-time discussion between parties, expensive cell phone plans must be purchased, and one does not always monitor their cell phone for instant reply to calls or text messages. For instance, when one is at home, the email account and the cell phone may be turned off so as not to be interrupted while eating dinner with the family or while watching the television. There are therefore scenarios when modern communications systems are inadequate in delivering the message, thereby lowering the quality of communications between parties.

This is especially true in certain contexts, such as healthcare communications between healthcare providers and remote patients. For instance, with aging and geographically diverse populations, along with rising healthcare costs, delivery of healthcare communications to and from remote locations with real-time capabilities has become a critical need. Older populations requiring ongoing health monitoring are at a disadvantage because of hardship in being able to routinely visit a healthcare provider. Geographically spread populations often find visits to or from doctors are especially difficult, and the problem is compounded when ongoing healthcare monitoring is needed for these distant patients. Further, the cost of delivering healthcare to patients who must physically visit healthcare providers has increased tremendously in recent years. Other burdens and risks of inpatient visits include overhead costs such as temperature control and labor, cleanliness issues, the emotional stress of being away from home, and risk of infection.

While effective communication with remote patients has benefits, it also creates problems to be addressed. It is harder to verify compliance with taking prescribed medicines or with performing prescribed regimens. Remote patients also create the issue of deficient reporting. Reporting the status of a medical condition greatly influences the success of medical treatment. A lack of reporting may also lead to greater costs and burdens on the healthcare system, as delays in addressing negative changes in condition may lead to readmission to the hospital. Reporting can also assist with assessing the quality and success of medical devices implanted or worn by patients, such as hip replacements.

To address these issues, some healthcare providers have used the internet to receive information regarding patients' health condition. However, not all homes are equipped with internet capabilities, and further there exists the need for bi-directional communication, i.e. the ability to communicate information back to the patients from the healthcare provider. Conventional attempts to communicate with remote patients have the shortcoming of relying on internet connections, and they also lack the ability to communicate information to the patients in a way that is hard for the patients to miss or disregard. One of the biggest problems with healthcare in general is patient compliance with the doctor's orders. Conventional attempts to convey information from healthcare providers to remote patients have not addressed this larger general problem. Many communications do not sufficiently and conveniently grab the patient's attention in a timely manner, for instance email, phone calls, websites, or text messages can all be easily disregarded, dismissed or ignored.

Timely exchange of information between patients and healthcare providers is critical in ensuring optimal outcomes in healthcare delivery. The sooner a healthcare provider knows about a patient's medical condition, the faster the healthcare provider can provide treatment or instructions to the patient, increasing the likelihood of a positive outcome. Likewise, the sooner a patient can receive instructions from a healthcare provider, the more likely the patient is to receive the treatment or instructions in a timely manner such that the medical condition is optimally addressed. Conventional means of communicating, as mentioned above, have shortcomings that may not always provide for communications between healthcare provider and patient that are conducive to a timely exchange of information.

Similar problems with conventional communications systems exist in the security and parenting contexts. For instance, with home security or when parents are away, those at home may be watching television but may turn off or silence a cell phone. Further, in many homes, the cell phone has replaced the land line phone, meaning security monitors in such a situation cannot reach the at-home viewer by any phone. In these and other contexts, the ability to communicate information back in real-time is critical.

Some communication efforts to address these problems have recognized the ubiquity of certain communications media in the modern home, such as the television or computer, and have sought to take advantage of this cornerstone. Delivering information via the television, for example, is a convenient and more assertive way to get the attention of someone who is not checking email, does not have their cell phone nearby or turned on, or is similarly disconnected from various other means of communication. However, conventional attempts using the television have required that a viewer make an affirmative action to receive the communication by switching to an input other than that on which the active television signal resides. Still other attempts have required that a viewer possess a certain type of television connection in order to use the communication delivery system. Further, these systems do not allow for bi-directional communication, where a remote site can communicate to an at-home viewer, and an at-home viewer can also transmit communications to the remote site. Finally, real-time capabilities of such a system are also lacking. Accordingly, there exists a need for a universally applicable, real-time, convenient and assertive delivery of bi-directional and interactive communications using an active communications signal.

### SUMMARY

The system and methods of the present development have several aspects, no single one of which is solely responsible for its desirable attributes. Without limiting the scope of this development as expressed by the claims which follow, its more prominent features will now be discussed briefly.

In a first aspect of the development, some embodiments of a method of overlaying an interactive and bidirectional message on a communications signal may comprise receiving a communications signal via a communications signal input connection of a hub, the communications signal comprising a communications signal resolution, and transmitting the communications signal to an overlay mixer circuit of the hub. The method may further comprise detecting with the overlay mixer circuit the communications signal resolution and communicating the communications signal resolution from the overlay mixer circuit to a processor of the hub. The method may further comprise receiving an overlay signal via an overlay signal input connection of the hub, the overlay signal comprising an overlay signal resolution, matching the overlay signal resolution to the communications signal resolution, and processing the overlay signal to produce an overlay message with a background having a level of transparency. The method may further comprise adjusting the level of transparency of the uniform background in the overlay message, transmitting the overlay message to the overlay mixer circuit, overlaying the overlay message onto the communications signal using the overlay mixer circuit to produce an overlaid communications signal, and transmitting the overlaid communications signal via a communications signal output connection of the hub.

In some embodiments, the method may further comprise receiving the communications signal from a first source and the overlaying signal from a second source and transmitting the overlaid communications signal from the hub to a television for display of the overlaid communications signal.

In some embodiments, the method may further comprise receiving data from at least one of an input device or portal, and transmitting the data from the hub to the second source, wherein the second source may be remotely located.

In some embodiments, the method may further comprise analyzing the data transmitted to the second source.

In some embodiments, the method may further comprise transmitting a second overlay signal to an overlay signal input connection of the hub.

In some embodiments, the overlaid communications signal may comprise an inquiry to which a patient may respond.

In some embodiments, the overlaid communications signal may comprise instructions for a patient to take a measurement with a medical device.

In some embodiments, the first source may be a television signal provider and the second source may be a healthcare provider.

In some embodiments, the method may further comprise receiving a communications signal comprising frames of a first video, receiving an overlay signal comprising frames of a second video, or synchronizing first and second video frames.

In some embodiments, the method may further comprise buffering at least one of the second video frames in an external memory, or reading out the overlaid communications signal from the buffering by following a timing of the first video.

In another aspect of the development, some embodiments of a system for bidirectional and interactive communication between a remote location and a data center over an active communications signal may comprise a hub that may comprise a communications signal input connection, an overlay mixer circuit, a processor, an overlay signal input connection, and a communications signal output connection. The system may further comprise a portal that may comprise a transceiver and be configured to receive data from a sensor and the hub, or an input device configured to wirelessly communicate with the hub. The hub may be configured to receive a communications signal through the communications signal input connection, and the communications signal may comprise a communications signal resolution. The hub may be further configured to transmit the communications signal to the overlay mixer circuit, detect with the overlay mixer circuit the communications signal resolution, or communicate the communications signal resolution from the overlay mixer circuit to the processor.

In some embodiments, the hub may be further configured to receive an overlay signal through an overlay signal input connection, where the overlay signal may comprise an overlay signal resolution, and to match the overlay signal resolution to the communications signal resolution. The hub may be further configured to process the overlay signal to produce an overlay message with a uniform background having a level of transparency, adjust the level of transparency of the uniform background in the overlay message, and transmit the overlay message to the overlay mixer circuit. The hub may be further configured to overlay the overlay message onto the communications signal with the overlay mixer circuit to produce an overlaid communications signal and transmit the overlaid communications signal through the communications signal output connection. The portal may be further configured to transmit the data received from the sensor and the hub to a remote data center and receive message data from the remote data center and transmit it to the hub.

In some embodiments, the communications signal may be a television signal and the output connection may be configured to output the overlaid communications signal to a television.

In some embodiments, the overlaid communications signal comprises an inquiry to which a patient may respond with the input device.

In some embodiments, the overlaid communications signal comprises instructions for a patient to take a measurement with a medical device.

In some embodiments, the medical device communicates measurement data to the portal.

In some embodiments, the overlaid communications signal comprises at least one of text and an image and a video.

In some embodiments, the hub may be a CN5® device.

In some embodiments, the input device may be a radio frequency keyboard.

In some embodiments, the portal may be a 2Net® device. In some embodiments, the system may further comprise a modem and wireless router configured to communicate with the hub.

In another aspect of the development, various embodiments of a device for bidirectional and interactive communication with one or more data centers over an active communications signal are disclosed. The device may comprise a communications signal input connection configured to receive a communications signal; an overlay signal input connection configured to receive an overlay signal from a first data center; an overlay mixer circuit configured to receive data related to the communications signal and to the overlay signal and to provide instructions to a processor for performing a method comprising overlaying the overlay signal onto the communications signal to produce an overlaid communication signal; an overlaid communications signal output connection coupled with the overlay mixer circuit and configured to transmit the overlaid communications signal to a display device; an input coupled with the processor and configured to receive an input signal from an input device; and a portal output coupled with the processor and configured to transmit data related to the input signal to a second data center. In some embodiments, the device may include a portal input configured to receive information over a network. The portal input may be configured to receive information over the network from a 2NET® device. In some embodiments, the information is received over the network from a medical device. In some embodiments, the device may include a resolution module configured to provide instructions to the processor to perform a method comprising matching a first resolution of the communications signal with a second resolution of the overlay signal. In some embodiments of the device, the first data center is the second data center. The first and second data centers may be healthcare providers. In some embodiments, the communications signal may be a television signal and the display device may be a television. The input device may be a remote. The remote may be a radio frequency keyboard.

### BRIEF DESCRIPTION OF THE DRAWINGS

The above and other aspects, features, and advantages of the development will be better understood by referring to the following detailed description, which should be read in conjunction with the accompanying drawings, in which:

FIG. 1 illustrates an embodiment of a system for overlay of remote communications on a television signal.

FIG. 2 is a flow chart illustrating an embodiment of a method of using the system depicted in FIG. 1.

FIG. 3 illustrates another embodiment of a system for overlay of remote communications on a television signal.

FIG. 4 illustrates an embodiment of the system of FIG. 1 without a modem.

FIGS. 5A-5C are block diagrams illustrating embodiments of a hub.

FIGS. 6A-9B are flow charts illustrating embodiments of some steps of the method depicted in FIG. 2.

FIG. 10 is a flow chart illustrating an embodiment of a method of a hub receiving and transmitting information for television overlay.

FIG. 11 illustrates an embodiment of the system of FIG. 1 comprising a beacon.

FIGS. 12A-12F are flow charts illustrating embodiments of the system of FIG. 1 in different contexts.

FIGS. 13A-13F illustrate embodiments of an overlay on a television.

FIG. 14 illustrates embodiments of a communications signal, an overlay signal, and an overlaid communications signal.

FIG. 15 illustrates an embodiment of an input device.

### DETAILED DESCRIPTION

Embodiments of the development will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the invention described herein.

Generally, the present disclosure concerns a device, system, and associated methods of using that device and/or system, related to overlay of interactive and bidirectional messages on a communications device via a communications signal. The device, system and related methods allow for such communications between remote locations where one of the locations has a communications device, such as a television. While the development is illustrated in embodiments including a television and television signal, it is applicable to other embodiments including, for example, a computer and associated data signals, or other communications devices that receive communications signals. Further, while the system and methods are illustrated with an embodiment including a healthcare provider monitoring a patient who is at a remote location and using a television, the system and methods may be used in other contexts and with other communications devices as well. Moreover, certain embodiments of the system may be used with devices having a wide range of capabilities, for instance with televisions with a variety of connection and resolution capabilities.

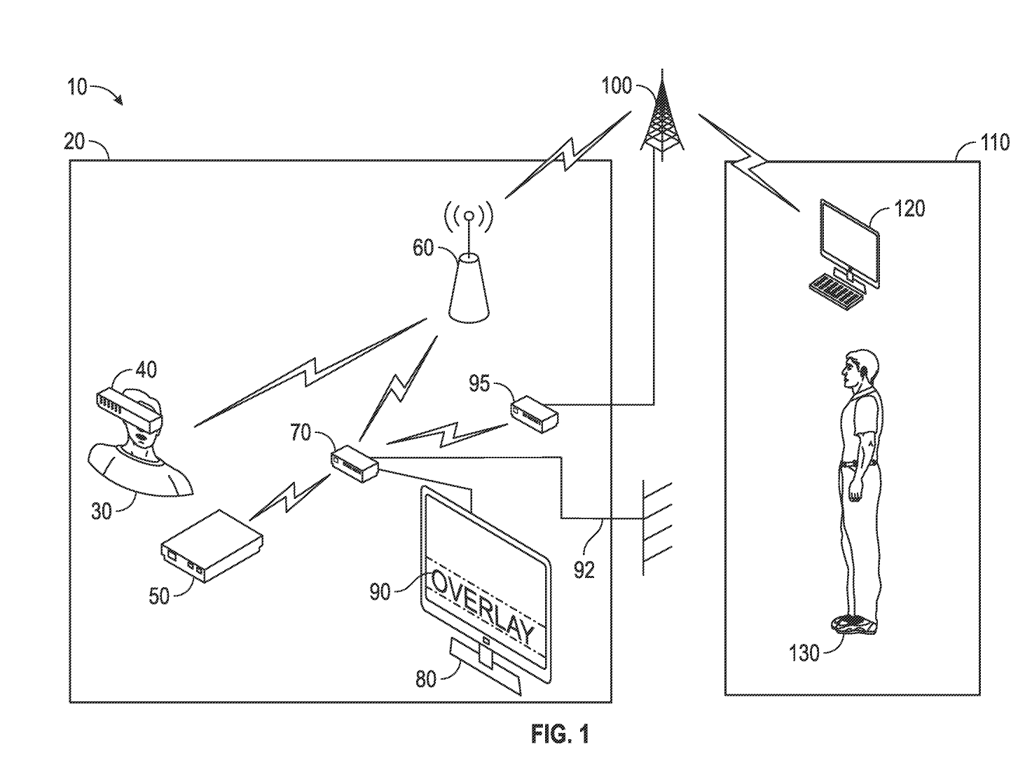

Referring to FIG. 1, an embodiment is shown of a system 10 for universal overlay 90 via a hub 70 onto a remotely located television 80 of information, providing for bi-directional and interactive communication between the remote location 20 and a healthcare provider 110. The remote location 20 is a place where a patient 30 is located. It may not be the healthcare provider location 110. The remote location 20 may be a home, an office, a log cabin, a vehicle, an assisted living facility, or any other number of locations. However, the remote location 20 may also be in the same vicinity as a healthcare provider location 110, or even in the same building or facility. Further, the remote location 20 need not have a conventional internet connection, such as cable or DSL that is available through an internet service provider, as the system 10 in some embodiments allows for network connectivity without such conventional internet connections, as is discussed in further detail herein. Any number of locations may suffice as a remote location 20 and will be readily apparent to one having ordinary skill in the art.

Located at the remote location 20 is a patient 30. The patient 30 is the source of the medical data of interest that is sensed and communicated to a healthcare provider location 110. The patient 30 may be a child, adolescent or an adult with any of a range of health conditions and requirements, including diabetes, cardiovascular, heart and other diseases, recovery from an operation, or taking prescribed medications. These or other patients 30 may also need monitoring. For instance, the patient 30 may be monitored for blood pressure, insulin level, number of doses of medication taken, or lifestyle monitoring such as frequency of trips to the refrigerator or of cigarette smoking.

For the system 10, the patient 30 may also comprise multiple patients and need not be a single person. For instance, a first patient 30 may be a monitored patient 30 who is the subject of the communicated healthcare information and from whom the medical information is being transmitted to a healthcare provider 110. A second patient 30 may be the one receiving and acting upon the communications sent from the healthcare provider 110 to the remote location 20, as well as the one who responds interactively to inquiries of the healthcare provider 110. This second patient could be a family member, friend, or caretaker who is located with or in communication with the first patient 30. A number of combinations of patient 30 roles may be implemented.

Further, the patient 30 need not be human. Other sources of medical data may be other objects that may be monitored, including any living organism, such as a plant or animal. For instance, the patient 30 may be a thoroughbred, a pet dog, or an azalea. In such cases, another human patient 30 would be receiving the healthcare communications and interactively responding to healthcare provider 110, but the subject of such communications would be the original patient 30. Many other forms of a patient 30 may be used in the system and will be readily apparent to one having ordinary skill in the art.

The medical data of a patient 30 is sensed with a sensor 40. The sensor 40 collects, processes, analyzes, and transmits in a suitable format the medical data or information regarding the patient 30 to a portal 60. The sensor 40 may be any number of devices, medical or otherwise, including a blood pressure cuff, a blood sugar monitor, thermometer, a drug bottle weight sensor, a refrigerator door motion sensor, or a cigarette smoke sensor. The sensor 40 is shown in FIG. 1 implemented on the person of a patient 30, but it may or may not be on the patient's body. This type of sensor may be, for instance, a blood pressure cuff wrapped around a patient's 30 appendage or a pacemaker implanted in a patient's 30 body. The sensor 40 may also indirectly interact with a patient 30. For instance, a sensor 40 installed with a bed to measure a patient's 30 heartbeat or breathing rate may relay data regarding cardiovascular or other function while a patient 30 sleeps or lies down.

The sensor may also be a device to alert a patient 30 to a message. In some embodiments, this type of sensor is an awareness beacon, as discussed in further detail herein, that alerts the patient 30 in some manner that a message has been communicated to the television. This is beneficial when, for instance, the patient 30 is outside or not in the same room as the television 80, when the patient 30 is not looking at the television 80 when an overlay 90 without audio has been sent, when the television 80 is not turned on, or when the patient 30 is otherwise unaware that an overlay 90 has been sent. The awareness beacon will inform the patient 30 that an overlay 90 has been sent to the television 80. The awareness beacon may be a separate device from the sensor 40, such as a lamp that lights up or an alarm that beeps, and is further discussed in detail herein. It may also be a part of the sensor 40 itself. The awareness beacon could likewise be a combination of an alert built into the sensor 40 as well as a separate device. The awareness beacon could also be a patient's 30 cell phone or other mobile device. Many other devices which relay information regarding the health or medical status of a patient 30, or alert a patient 30 to an overlay 90, may be implemented and will be readily apparent to one of ordinary skill in the art.

The sensor 40 transmits signals to a portal 60. In one embodiment, the sensor 40 communicates with the portal 60 by wireless Bluetooth technology. In other embodiments, other means of connections are possible, including other wireless or wired technologies or connections. From the portal 60, the signals may be transmitted to a network 100 and/or a hub 70. Either of these routes may be used to transmit the information to a healthcare provider 110.

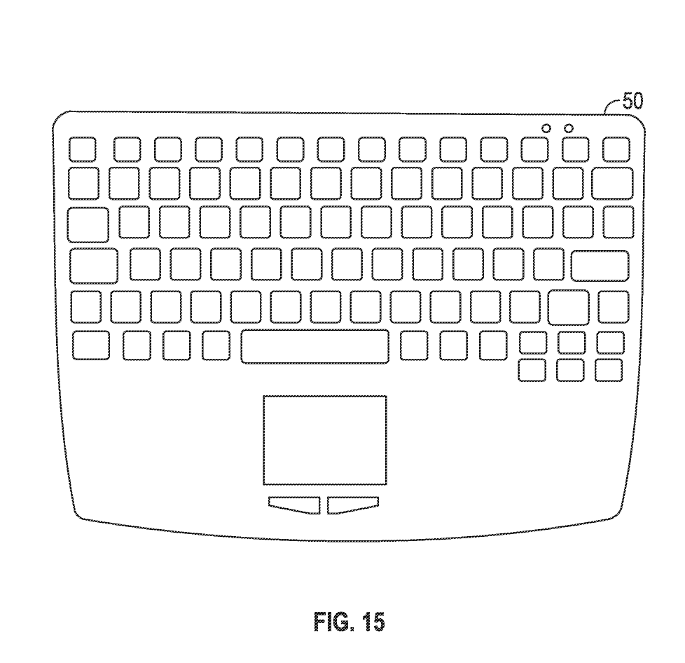

The sensor 40 is one means by which a patient 30 can communicate information to and from a hub 70. Another means of communicating information with a hub 70 is an input device 50, as shown in FIG. 1. An input device 50 provides a peripheral control by which a patient 30 may interact with the information being communicated by a television 80 by transmitting information to the hub 70. The input device 50 is a keyboard, but it also may take a number of forms, for instance a remote control, a cell phone, a tablet, or a computer. The input device is discussed in further detail below, for example with respect to FIG. 15.

In some embodiments, the input device 50 communicates with the hub 70 wirelessly by radio frequency (RF). It may also relay information using a number of other means, including wired, WiFi, Bluetooth, broadband, infrared, or any other device or means. The input device 50 may also be a combination of any of these devices and employ a combination of any of these means of communicating. Other such devices and methods will be readily apparent to one of ordinary skill in the art.

In some embodiments, the sensor 40 and input device 50 communicate with the healthcare provider 110 simultaneously. For instance, the sensor 40 may detect blood pressure data and continuously transmit this data via the portal 60 to the healthcare provider 110, while the patient 30 also uses the input device 50 to interact with the hub 70 to send data to the healthcare provider 110, which may be in response to an overlay 90 inquiry displayed on the television 80 from the healthcare provider 110.

An embodiment of a portal 60 is shown in the system 10 of FIG. 1. The portal 60 may receive information communicated from a variety of sources, including from the sensor 40 and from the input device 50 via the hub 70, as well as communications from the healthcare provider 110 via a network 100. For instance, the portal 60 may receive information from a sensor 40 about a patient's 30 blood pressure or insulin level. The portal 60 may also receive input via the hub 70 from a patient 30 using the input device 50, which information may be about a patient's 30 reported health state or compliance in taking medications.

In some embodiments, the mode of transmission of information to a portal 60 from the sensor 40 is passive. That is, information may be passively transmitted to a portal 60 from an automatically-initiated sensor 40. For instance, a sensor 40 may be continuously monitoring a patient's 30 respiration rate while the patient 30 sleeps. This information may in turn be continuously transmitted to the portal 60 without any action required by the patient 30. The passive transmission may also be conditional. That is, information may only be transmitted to a portal 60 from a sensor 40 once a condition has been met. For instance, if a patient's 30 respiration rate reaches a threshold level, then the sensor 40 may be programmed to passively transmit the information to the portal 60.

In some embodiments, the mode of transmission of information from an input device 50 to a portal 60 is manual. For instance, to respond to an overlay 90 inquiry on the television 80, a patient 30 may need to affirmatively act via an interface to transmit information through the input device 50 to the portal 60 via the hub 70. Such an interface may be a keyboard, for example, which may be used to type and submit a request, question, response to an inquiry, or other input.

In some embodiments, the sensor 40 or input device 50 may have a combination of passive and manual transmission modes. Further, one may use the passive transmission mode while the other uses manual, or vice versa, or they may simultaneously operate in passive or manual modes. Still other modes and combinations of modes of operating the sensors 40 and input devices 50 may be employed, such as operating in “pinged” or responsive modes, as is further discussed herein.

The portal 60 in some embodiments is a 2Net® device from Qualcomm Inc. The 2Net® device allows for receiving data from a variety of different medical device sensors 40 operating on different platforms. The 2Net® device and its associated methods may correspond to the device, system, and methods described in U.S. patent application Ser. Nos. 13/349,938 and 13/705,784, the contents of each of which are incorporated herein in their entirety. The 2Net® may comprise wireless communications devices and services enabling remote access to electronic medical or fitness devices in a manner that simplifies device networking. The wireless communication device may include a processor and wireless communication transceivers configured to connect to cellular and/or WiFi networks to access a remote server, and wired and/or wireless local networks for connecting to electronic medical or fitness devices. The wireless communication device may plug into a power source, connect to an electronic medical or fitness device, and communicate via a second wireless network with an associated server-based service. The system enables discovery of the wireless communication device and connected electronic medical or fitness devices. The associated remote server based service platform services may provide drivers for various electronic medical or fitness devices, store and forward data, and provide remote access to the various electronic medical or fitness devices.

A television 80 as embodied in FIG. 1 is a telecommunication medium that can display audio and video from a variety of sources. The television 80 may be used for watching audio and video signals broadcast from programming providers through a variety of means, such as cable, antenna, or satellite.

In communicating with the television 80, the portal 60 uses a hub 70. The hub 70 provides the overlay 90 onto and integrates with the television 80. The hub 70 contains hardware and software, as discussed in further detail herein, that allows it to perform various functions related to communications between a patient 30 and a healthcare provider 110 involving the television 80.

In some embodiments, the hub 70 is configured to allow for overlay 90 of a message on a television 80 by mixing or combining the overlay 90 with a video signal, such as the active television signal 92, to display on the television screen the television signal 92 with the overlay message 90 overlaid thereon. In FIG. 1, the active television signal 92 is shown as connecting to the hub 70, which then connects to the television 80. The television signal 92 is thus one input to the hub 70. Another input to the hub 70 is the overlay message 90 to be overlaid. As discussed in further detail herein, the overlay 90 may be received from an off-site healthcare provider 110. It is understood that, as used herein, the overlay 90 may refer to the actual displayed overlay message 90 on a television 80, as shown in FIG. 1, or it may refer to the signal or data that is intended to be displayed as an overlay 90.

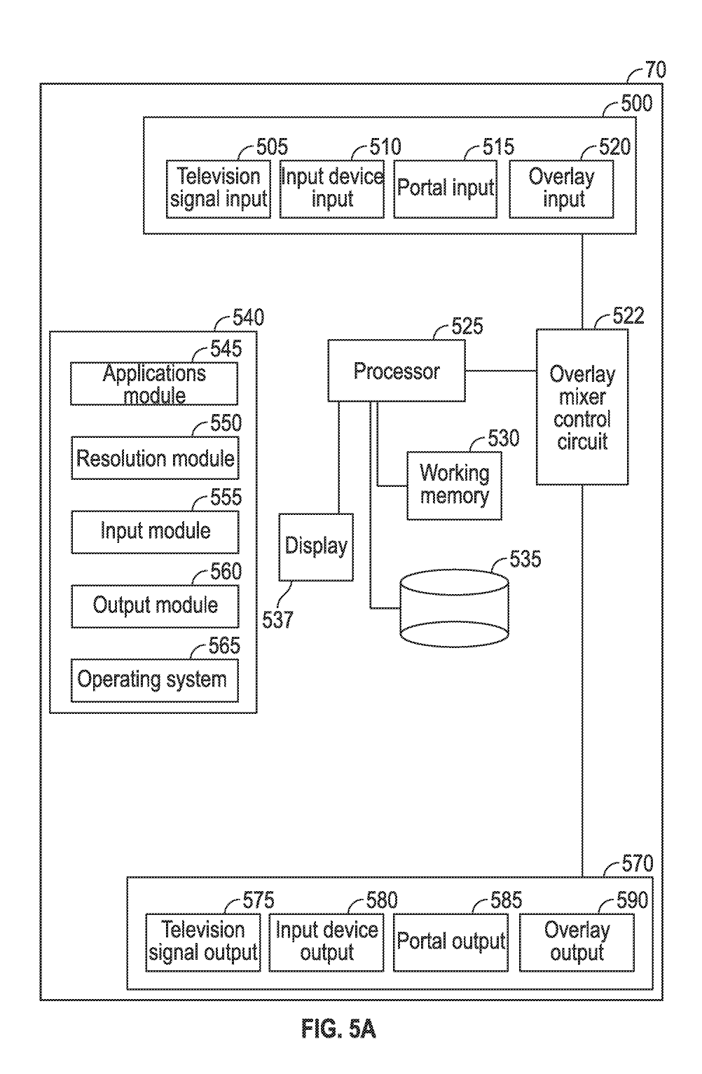

In some embodiments, the mixing or combining of a video signal such as a television signal 92 with an overlay message 90 is accomplished with an overlay mixer control circuit. The overlay message 90 may be received by the hub 70 and input to an application or program run by a processor in the hub 70, that will produce the message 90 to be overlaid, and then send it to the mixer control circuit. The mixer control circuit of the hub 70 will also receive a video signal, such as the television signal 92, and then mix or combine the signal 92 with the overlay 90, as is discussed in further detail herein. Next, the mixer control circuit will send the overlaid data to an output module in the hub 70 for output to a television 80. Further details of the hub 70 and mixer control circuit, as well as other hardware and software in some embodiments of the hub 70, are discussed herein, for example with respect to FIGS. 5A-5C.

The active television signal 92 that may be overlaid by a hub 70 may be from any source of a television signal. The hub 70 is therefore flexible in that it will allow for accommodation of any active television signal 92. For instance, the active television signal 92 may be provided through a cable box, from a satellite, through a digital video recorder (DVR), from pay-per-view (PPV) programming, etc. The active television signal 92 is shown in FIG. 1 in such a manner that it may be any of these sources of a television signal. Further, “active” here need not mean a live or current signal. It merely refers to the input source signal for the television. The hub 70 thus sits on the specific source input from where the television signal is received. Therefore, if the system 10 is installed in a remote location 20 where, for example, a DVR is part of the television provider device (e.g. cable box, satellite receiver, etc), then the overlay 90 will still display when a patient 30 is watching recorded programming or PPV streaming programs other than the live television signal. While the active television signal 92 is shown in FIG. 1 as originating from outside the remote location 20, this is merely for illustration. It is not meant to limit in any way the possible sources of the active television signal 92 that a patient is enjoying while receiving an overlay 90 on the television 80. For instance, a patient 30 may be watching a recorded program on a DVR which has already been recorded from an outside source and is now stored on the DVR in the remote location 20. The illustration of an active television signal 92 in FIG. 1 is meant to include this and other similar scenarios, and the schematic is not meant to limit the possibilities of the active television signal 92 in any manner.

The hub 70 is further adaptable for many types of television connections. For instance, the hub 70 may be configured to connect to the television 80 with composite video (also known as CVBS), component video (also known as YP_{B}P_{R} or YUV), or High-Definition Multimedia Interface (HDMI). In some embodiments, a single hub 70 may contain the adaptability to connect to any of a variety of connection types. For instance, a single hub 70 may have the capability to connect to either composite video, component video, or HDMI connections. In other embodiments, the hub 70 may be configured to connect to only a single connection. For instance, one embodiment of the hub 70 may be configured to connect to a composite video connection. Another embodiment of the hub 70 may be configured to connect to a component video connection. Still another embodiment of the hub 70 may be configured to connect to an HDMI connection. Many other variations of the hub 70 in terms of its capability to connect to different connections are possible. Further, the hub 70 may also contain an adapter to allow compatibility with other connections, including but not limited to S-video, CGA, VGA, digital visual interface (DVI), serial digital interface, Displayport, DiiVA, HDBaseT, or CoaXPress.

By providing an overlay 90 onto an active television signal, the convenience and effectiveness of the communication system is greatly enhanced. Rather than having to change channels or alter the signal input source, a viewer merely need be watching the active television signal 92. By operating on the active television signal 92, the hub 70 can easily and seamlessly assert an overlay 90 of the communication of healthcare or other information onto the television 80. This allows, for example, the healthcare provider 110 to assertively insert healthcare information directly onto the viewed screen of television 80 while a patient 30 is using the active television signal 92. As watching the active television signal 92 is a major use of the modern television 80, the current system 10 provides a much more assertive and effective means of communicating with remote patients 30. The chances for high quality communications are thereby immensely increased. This in turn greatly enhances the probability of a successful treatment outcome due to enhanced reporting from and monitoring of patients 30.

The hub 70 provides the further benefit of being configured to preserve the resolution of the active television signal 92 input to the television 80 and to accordingly adjust the resolution of an overlaid message 90. Since the hub 70 sits on the active television signal 92, it can influence whether the proper resolution is displayed on the television 80. If the hub 70 cannot transmit the active television signal 92 to the same level as would be viewed with that signal 92 on the television 80, then a patient 30 is not provided with the present capability of their television 80. The hub 70 therefore preserves the resolution that is sent with an active television signal 92 such that it delivers the signal 92 to match the resolution displayed on the television 80.

Further, the hub 70 may adjust the resolution of the overlay message 90 to correspond to the resolution of the input television signal 92. As is discussed in further detail herein, the mixer control circuit of the hub 70 transmits the resolution of the television signal 92 to the processor of the hub 70 through a register. The processor will then adjust its own video resolution to the same resolution of the television signal 92. For example, the hub 70 may be configured to allow for viewing of television programming on a television 80 with resolution capabilities of standard-definition television (SDTV) resolution of 480i or 576i, enhanced-definition television (EDTV) resolution of 480p or 576p, high-definition television (HDTV) resolution of 720p, 1080i, or 1080p, or ultra-high-definition television (UHDTV) resolution of 2160p, 4320p, or 8640p. This preservation of the resolution is crucial because the hub 70 operates on the active television signal 92, as mentioned. The overlay message 90 will also be adjusted to match the same resolution as the television signal 92. Without these capabilities, the resolution and therefore enjoyment of the television 80, as well as the effectiveness of the overlay message 90, may be compromised.

This overlay 90 of information need not interrupt, disrupt, or otherwise impair the television 80 content being viewed. The overlay 90 can occupy a small portion of the entire viewing display of the television 80. For instance, the overlay 90 may be a banner running along the top or bottom of the display that only takes up a few inches in height or small percentage of viewing space. The viewer of the television 80 may still be able to see and hear the television 80 content while the overlaid healthcare content is shown. The overlay 90 may also be larger, taking up half of the screen of the television 80 or in some cases the entire screen. For example, if an urgent message is sent for an overlay 90, then a larger portion of the screen of television 80 may be occupied.

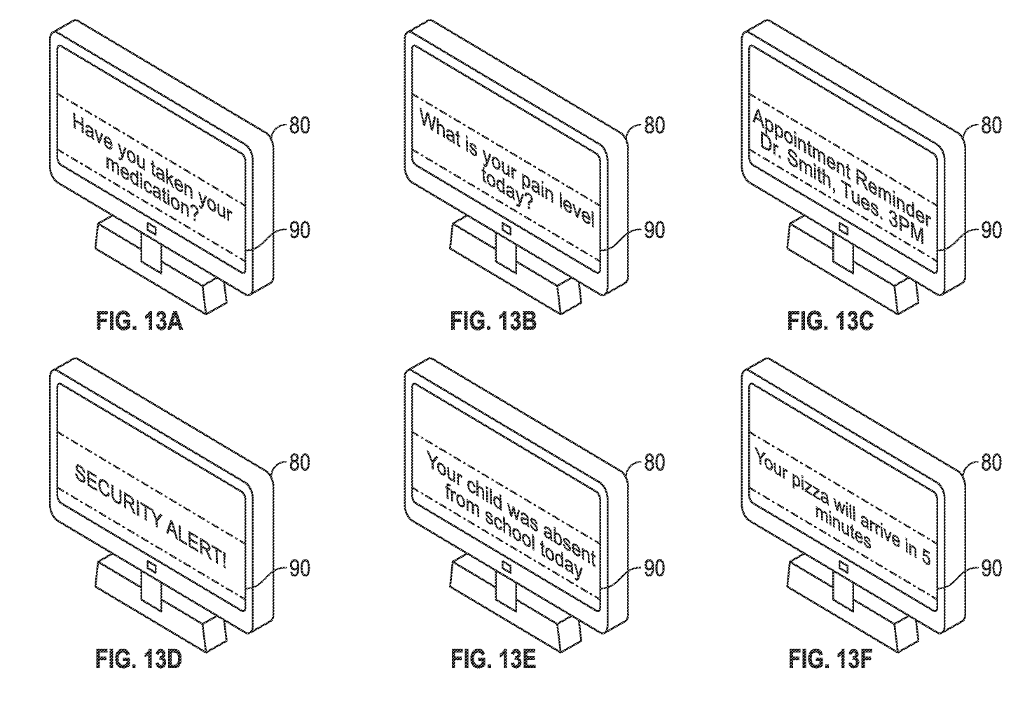

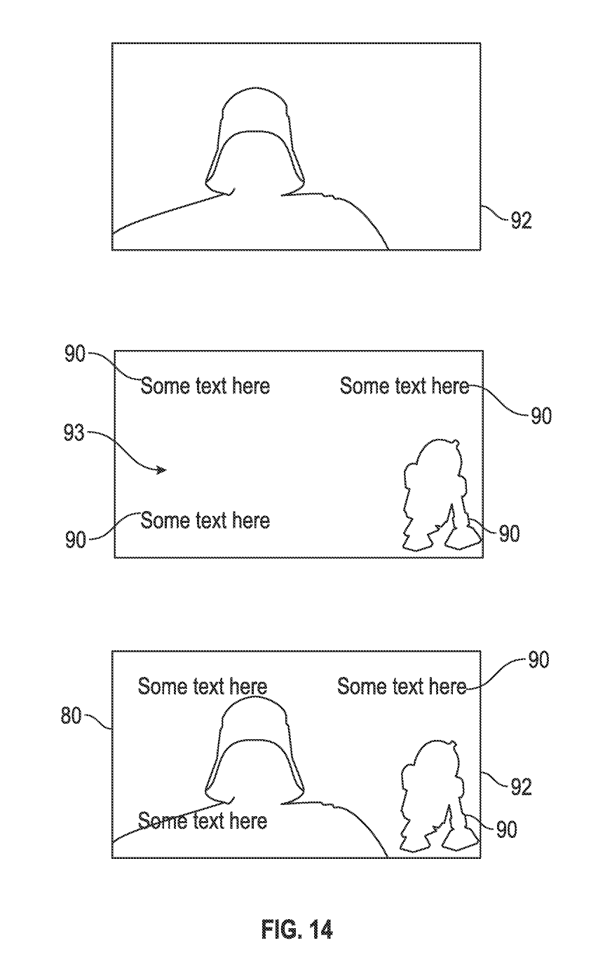

Further, the overlay 90 may be entirely opaque such that the television content behind it cannot be seen, or the overlay 90 may be somewhat transparent such that the television content behind it can be somewhat seen. The overlay 90 further may not be static with regard to size or transparency. For example, an initial message in an overlay 90 may be transparent and occupy a small banner along the bottom of the television screen, and it may later be opaque and occupy a larger portion of the screen. Many combinations of the size, transparency and other characteristics of the overlay 90 may be implemented, and certain examples are given only to illustrate some of the possible combinations. Variations in displaying the overlay message 90 are discussed in further detail herein, for example, with respect to FIGS. 13 and 14.

The format of an overlay 90 may likewise take a variety of forms. For instance the overlay 90 may be video and/or audio. This can include any of text, still images, moving scenes, alerts, sounds, or any combination thereof. The format for an overlay 90 is not meant to be limited by these examples, and may take any other number of formats not explicitly listed, for example cartoon animations, 3-D images, projections, etc.

The content of an overlay 90 may comprise a number of different types of messages. For instance, an overlay 90 may be a unidirectional message to a patient 30 or observer of the television 80 that does not request interaction or response from the patient 30 or observer. For instance, an overlay 90 message may display the message “It is time to take your medication.”

The overlay 90 content may also consist of a bidirectional message to the patient 30 or observer of the television 80, where the content requests interaction or response from the patient 30 or observer. For instance, the overlay 90 message may display the message “Have you taken your medication today?” In such a case, a manual gathering of information from the patient 30 or observer to the healthcare provider 110 is necessary. For instance, a patient 30 may respond to the overlay 90 content by using the input device 50 to respond “yes” to the inquiry from the healthcare provider 110. If the input device 50 is a keyboard, the keyboard may be used to type in the answer “yes” which may be displayed in or near the overlay 90 area on the television 80. The patient 30 may thereby verify the response they are giving, can see it, and can verify that it is being sent back to the healthcare provider 110.

While an interactive response to an overlay 90 inquiry is considered “bi-directional,” the use of an input device 50 to communicate back to a healthcare provider 110 need not be in response to an inquiry. For instance, the patient 30 may use the input device 50 to initiate communication of healthcare information to the provider, such as volunteering information regarding compliance with taking prescribed medications. Further, bi-directional refers not only to communication from a remote patient 30 using an input device 50 to a healthcare provider 110, but also to communication of healthcare information originating from a sensor 40 that is transmitted to a healthcare provider 110. “Bi-directional” thus has a variety of aspects and implementations with regard to system 10.

The transmission of information from the healthcare provider 110 to an overlay 90 on a television 80 of the remote patient 30 may be automatic. For instance, the overlay 90 may consist of a pre-programmed message that is set to go out at set intervals, such as a reminder every day at a certain time. The overlay 90 may also be sent out automatically in response to information sent from a remote patient's 30 sensor 40 back to a healthcare provider 110. For instance, if the sensor 40 detects that a patient's 30 blood sugar is too high, then this information may be sent to the hub 70 which transmits it to the healthcare provider 110. The provider may in turn have a computer set up to receive this information and respond automatically, without the need for a human healthcare provider 110, to overlay 90 a message on the remote patient's 30 television 80 that an insulin dose is needed.

The transmission of information from a healthcare provider 110 to an overlay 90 on a television 80 set of a remote patient 30 may also be manual. For instance, a human healthcare provider 110 may view data received from a remote patient's 30 sensor 40, such as blood sugar levels being too high. The human healthcare provider 110 may then manually input an overlay 90 message to be sent to the remote patient's 30 television 80.

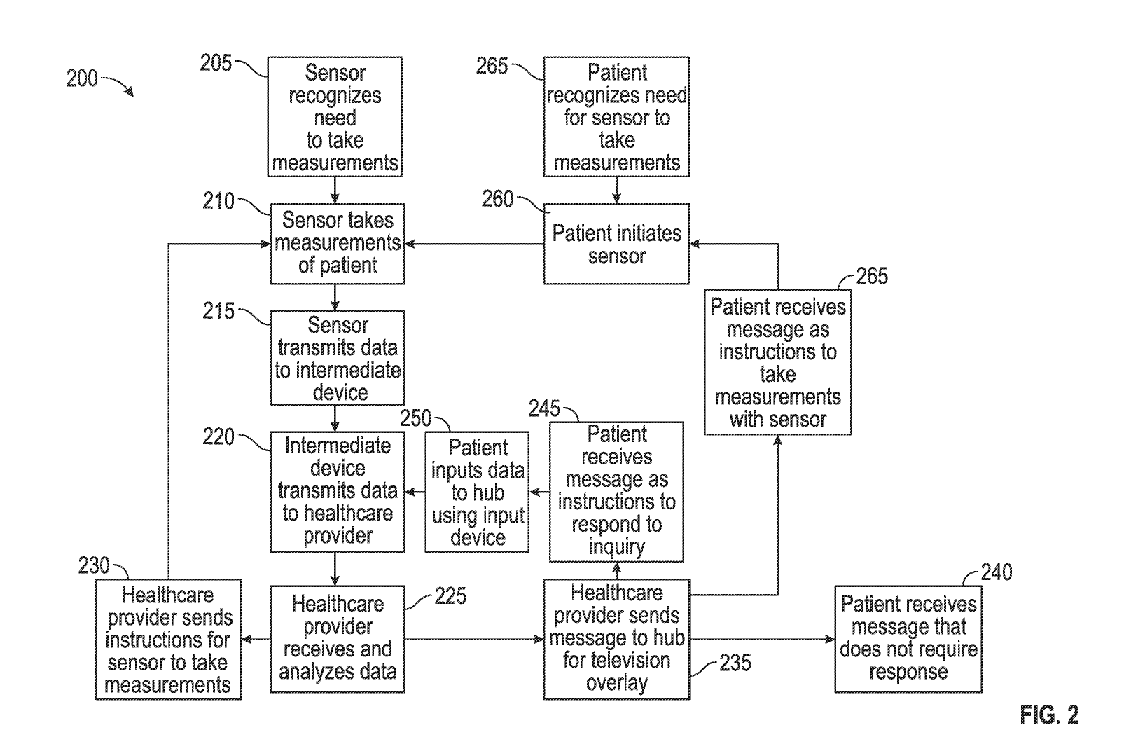

While some of the properties of the system 10 have been discussed above, the various processes and procedures that the system is capable of are discussed in further detail below. The above is merely an illustration of some of these properties in the context of the embodiment shown in FIG. 1. Other interactions and properties of the system 10 are possible, as will be further discussed later with respect to, for example, FIG. 2.

As further shown in FIG. 1, the remote location 20 can communicate with the healthcare provider 110 by a network 100. An embodiment of the network 100 as shown in FIG. 1 allows for communication between the portal 60 and the healthcare provider 110. The network 100 may be wireless, such as a cellular network 100 that allows communication of a portal 60 with a cell tower, which then ultimately communicates with the healthcare provider 110. In some implementations, the network 100 is a 3G cellular network.

In some embodiments a Wi-Fi router 95 is also used to communicate with the network 100. The Wi-Fi router 95 is any wireless communications device capable of transmitting and receiving the signals from the hub 70 and network 100. In some embodiments, the portal 60 communicates directly with the network 100 and the hub 70 connects via the Wi-Fi router 95 to the network 100. The Wi-Fi router 95 is connected to the network by a cable or DSL modem or other means of connecting to the network 100. In FIG. 1, the Wi-Fi router 95 is connected to a cable or DSL modem (not shown) which receives an internet signal that is wired into the remote location 20 from a network 100. The communication between the Wi-Fi Router 95 and the hub 70 is wireless in the embodiment shown in FIG. 1. However, the Wi-Fi router in some embodiments is connected to the hub 70 by wire, such as an Ethernet connection. In some embodiments, the internet signal may be supplied through other channels, including but not limited to satellite, microwave, RF, cellular, etc.

FIG. 1 further illustrates an embodiment of a healthcare provider 110. The healthcare provider 110 is a hospital, a doctor's office, a specialist's office, a data center, or any other type of facility or person or place associated with collecting, analyzing, and/or providing healthcare-related information. A healthcare provider 110 may provide the healthcare information that is being transmitted to a remote patient 30. Information being transmitted to a patient 30 may be manual or passive, for example it may be manual input from a human at healthcare provider 110 or an automatic response from a data center. A healthcare provider 110 may also receive passive as well as manual data from a remote patient 30. Passive data may be the data from a remote patient's 30 sensor 40. Manual data may be the responses or volunteered information from a patient 30 input with an input device 50. A healthcare provider 110 may be located anywhere that it can communicate with a network 100.

The healthcare provider 110 is shown with an embodiment of a communication system 120. The communication system 120 allows the healthcare provider 110 to transmit communication to the hub 70 in the remote location 20. The communication system 120 is typically a computer in communication with a network 100. The communication system 120 may also be any number of devices capable of communicating with a network 100, for instance a laptop, a desktop PC, a cell phone, a tablet, or any number of other devices having such capability.

The healthcare provider 110 in some embodiments includes a medical professional 130. The medical professional 130 is a person administering healthcare to the remote patient 30. The medical professional 130 may be any number of professionals in the medical field, for instance a doctor, a specialist, a surgeon, a pharmacist, a nurse, a physician's assistant, or any other number of medical professionals 130.

The embodiments of a system 10 may be used in accordance with a variety of methods. FIG. 2 illustrates an embodiment of a method 200 for universal overlay 90 onto a remotely located television 80 of healthcare information providing for bi-directional and interactive communication between the remote location 20 and a healthcare provider 110. The method 200 of using system 10 is a continuous process with no required starting or end point, and it may proceed according to a variety of paths once initiated. It is therefore understood that any step in method 200 to begin description is chosen arbitrarily as an illustration. A number of other steps in method 200 may likewise be chosen to begin description, and the method may be practiced according to a variety of starting points. Further, method 200 may also be interrupted, paused, or otherwise delayed between the various steps and need not continuously occur.

### Sensor-Initiated Sensing

One embodiment of the method 200 is a sensor-initiated method. In an implementation of this embodiment, the sensor may be initialized in step 205 by the sensor. For example, the sensor may be programmed to take measurements at specified times or at a time in one or more defined time periods to monitor a patient's condition. Alternatively, the sensor may take measurements in response to detecting a change in a patient's condition. Once the sensor is initialized, the process then moves to step 210 where the sensor takes the measurements to be reported to a healthcare provider by sensing or detecting medical information such as vital signs from the patient. Once the sensor has taken the measurements, the sensor transmits the data to an intermediate device, such as a hub and/or a portal, in step 215. Next, in step 220, the intermediate device receives the data from the sensor and transmits it to a healthcare provider. The healthcare provider then receives and analyzes the data in step 225. If the healthcare provider determines that more measurements are needed from the sensor, then in step 230 the healthcare provider sends instructions for the sensor to take measurements. The process then continues at step 210 with the sensor taking measurements of the patient, and it may proceed as further detailed in this or other embodiments and implementations of the method 200.

In another implementation of the sensor-initiated embodiment of method 200, the healthcare provider receiving and analyzing data in step 225 may, instead of or in addition to sending instructions for the sensor to take measurements in step 230, send instructions to the hub for television overlay in step 235. In this step, the instructions are displayed on the television as an overlay for the patient to view. From step 235, a variety of instructions or messages may be sent. The instructions sent from step 235 to the patient may not require a response, as shown by step 240. In this implementation, the patient views the instructions on the overlay and is not required to respond. For instance, the instructions may instruct the patient with a reminder for an upcoming medical event, such as an appointment reminder.

In an additional implementation of the sensor-initiated embodiment of method 200, the instructions sent by the healthcare provider from step 235 to the hub for television overlay may instruct the patient to respond to an inquiry, as shown by step 245. In this implementation, the patient then responds in step 250 by inputting data to the hub using the input device. An intermediate device, such as the hub or portal, then transmits this data to the healthcare provider in step 220, and in step 225 the healthcare provider receives and analyzes the data. The healthcare provider from step 225 may proceed as further detailed in this or other embodiments and implementations of the method 200.

In a further implementation of the sensor-initiated embodiment of method 200, the instructions sent from the healthcare provider in step 235 may instruct the patient to take measurements with the sensor, as shown in step 255. In this implementation, the patient next initiates the sensor in step 260 and then the sensor takes measurements of the patient in step 210. From step 210, the process may proceed as described herein.

### Patient-Initiated Sensing

Another embodiment of the method 200 is a patient-initiated sensing method. In an implementation of this embodiment, the patient in step 265 recognizes the need for the sensor to take measurements. For example, the patient may notice that a medical condition has changed or occurred, such as having a high temperature or feeling lightheaded. The process then moves to step 260 where the patient initiates the sensor and the sensor takes measurements of the patient in step 210 by sensing or detecting medical information such as vital signs from a patient. Once the sensor has taken the measurements, the process may proceed as described above.

### Provider-Initiated Sensing

An additional embodiment of the method 200 is a healthcare provider-initiated sensing method. A healthcare provider may initiate the process by, for example, recognizing a set schedule or reacting to new information. In an implementation of this embodiment, the healthcare provider in step 230 sends instructions for the sensor to take measurements. The process then moves to step 210 where the sensor takes the measurements by sensing or detecting medical data from a patient. Once the sensor has taken the measurements, the sensor transmits the data to an intermediate device, such as a hub or portal, in step 215, and may proceed as described above.

### Patient-Initiated Reporting

An additional embodiment of the method 200 is a patient-initiated reporting method. A patient may initiate the process by, for example, desiring to share new information with the healthcare provider, or the patient may wish to make a scheduled check-in or follow up to the healthcare provider. In an implementation of this embodiment, the patient in step 250 inputs data or information to the hub using the input device. The process then moves to step 220, where an intermediate device, such as the hub or portal, receives the data from the sensor and transmits it to the healthcare provider. The healthcare provider then receives and analyzes the data in step 225, and the process may proceed as described above.

### Provider Message to Patient

An additional embodiment of the method 200 is a provider message method where a healthcare provider initializes the process. The healthcare provider may desire, for example, to check in on a patient who missed an appointment or whose sensor has not made expected transmissions of medical data. In an implementation, the healthcare provider sends instructions or messages to the hub for overlay onto the television of a patient, as shown in step 235. The message sent from step 235 to the patient may not require a response as shown by step 240, may instruct the patient to respond to an inquiry as shown by step 245, or may instruct the patient to take measurements with the sensor as shown in step 255. Further, the provider may send multiple messages of the same type or of mixed type. For instance, the provider may send an instruction as in step 245 as well as a message as in step 240. The process may then proceed as described above.

The method 200 shown in FIG. 2 illustrates some of the possible processes, steps and workflow that the system may implement. Various combinations and permutations of these steps are possible and not all are explicitly addressed. Further, multiple processes described above may occur simultaneously with a system 10. For instance, a message requiring response in step 245 as well as instructions to take a measurement in step 255 may both be sent. Then, the process may proceed simultaneously to steps 250 and 260, where the patient inputs data to a hub as well as initiates a sensor, respectively. Other such simultaneous combinations of the processes described above may be implemented. It is understood that the above descriptions are merely illustrations of some of the embodied processes and capabilities and do not limit the scope of the present disclosure. Further, the method 200 shown in FIG. 2 is merely an overview of a process that the system 10 may follow. Details of various steps in that process are further described herein, some with respect to other figures. These detailed aspects are understood to be capable of integration into the steps shown in FIG. 2. For example, where step 215 in FIG. 2 shows that a sensor is transmitting data to an intermediate device, it is understood, as further discussed herein, that this may include the intermediary step of transmitting the data to a hub and/or to a portal. The steps shown in FIG. 2 are therefore an overview intended to illustrate the overall processes, while details of the various steps of those processes are further discussed herein and may be integrated into the larger process.

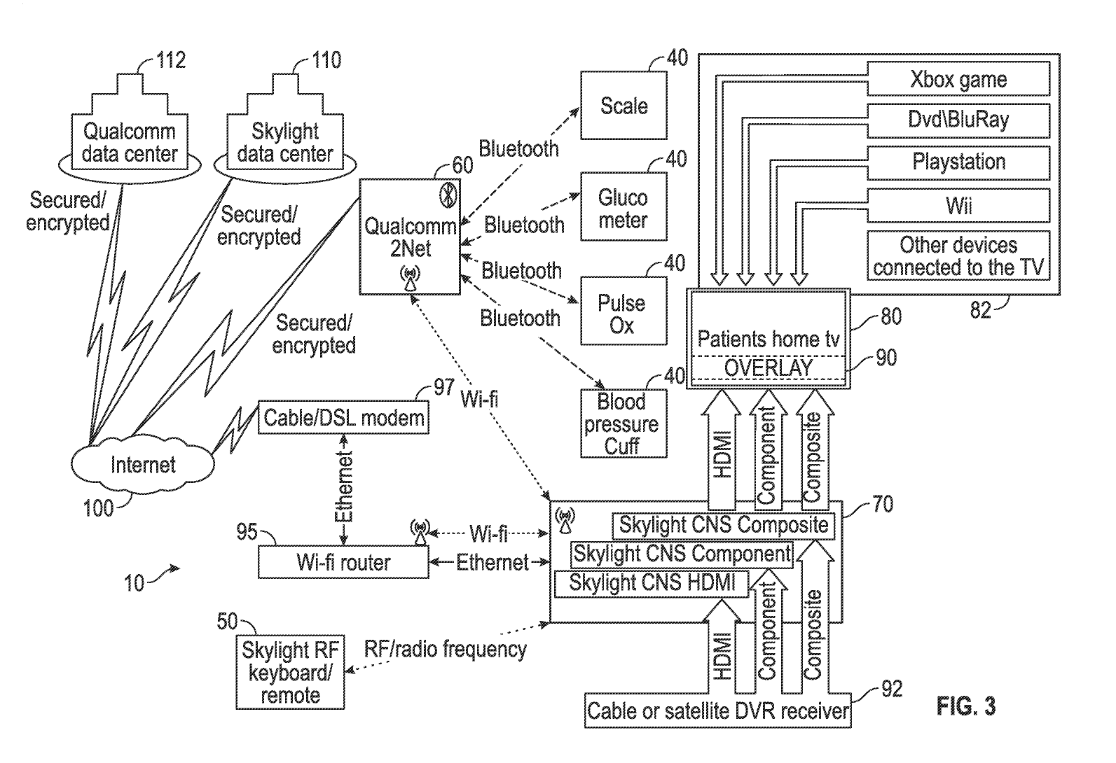

The overall method 200 as depicted in FIG. 2 may be carried out on the embodiment of the system 10 as illustrated in FIG. 3 in the healthcare context. As shown, the system 10 includes various medical devices as sensors 40, including a scale to measure weight, a glucometer to measure blood sugar level, a pulse oximeter (Ox) to measure blood oxygen content, and a blood pressure cuff to measure blood pressure level. Some of these sensors 40, like the glucometer, pulse oximeter, or blood pressure cuff, may be worn by a patient 30. Others, such as the scale, may be devices or sensors 40 in the remote location 20 that are not worn by the patient 30.

As shown in FIG. 3, the portal 60 that these sensors 40 communicate with may be a 2Net® device from Qualcomm, Inc. The 2Net® receives information from the various sensors 40 by Bluetooth or other wireless connection, as well as provides a Wi-Fi or other wireless connection with a hub 70. The 2Net® then provides a secure or encrypted connection with a network 100, in this case the internet, such that the data or information may be securely transmitted to various data centers. For example, the healthcare provider 110 in this embodiment may be a data center operated by Skylight® Healthcare Systems. Such data centers facilitate post-care or discharge solutions by providing, among other things, discharge instructions, medication and/or rehab schedules and information, follow up appointments, diet and exercise videos and instructions, or maps and driving directions to physicians, care providers and the hospital. The data is transmitted to the Skylight® Data Center by secure or encrypted connection, and the center can then receive, process, analyze, and take an appropriate response to the information. The data may also be sent from the 2Net® via a network 100, such as the internet, to a Qualcomm® Data Center 112 by secure or encrypted connection. This information may be used by the Data Center 112 to collect data, for example, related to the functioning of the 2Net® and associated devices for various purposes, such as monitoring of product quality and use.

The 2Net® as portal 60 provides multiple network connectivity options for system 10. The 2Net® has various radios that allow it to connect to a multitude of different cellular network providers. The 2Net® can further determine which network is giving the strongest signal and transmit over that network. The multitude of connectivity options open to the 2Net® therefore provides flexibility and efficiency to system 10, especially when a traditional internet connection, such as through a modem and Wi-Fi router, is not available.

The various data centers may send information or commands back to the remote location 20 via the secure connection over the internet network 100. This data is then transmitted to the cable or DSL modem 97 at the remote location 20 which is connected to a Wi-Fi router 95 by an Ethernet connection. The Wi-Fi router 95 may be in wireless communication with the hub 70 or they may be connected by Ethernet cable.

The hub 70 in FIG. 3 is a Skylight CN5® device. The CN5® operates on the active television signal 92, which is shown as originating from either a cable or satellite DVR receiver. This receiver with the active television signal 92 may have an HDMI, a component, or a composite type connection. The CN5® is capable of adapting to any of these connection types, as shown by hub 70 and the three connections depicted: Skylight CN5® HDMI, Skylight CN5® component, or Skylight CN5® composite.

The CN5® is also in communication with an input device 50, which as shown in FIG. 3 is a Skylight radio frequency (RF) keyboard or remote. This device 50 allows for RF communication between it and the CN5®. A patient 30 uses the keyboard or remote to send data to the CN5® via the RF signal. The CN5® may also send data to the keyboard or remote device 50, for instance if the device 50 acts as an awareness beacon or message alert for the system, as is further discussed herein.

The CN5® is further capable of communicating directly with a portal 60, such as the 2Net® device, by Wi-Fi connection. This allows for direct transfer of data and information between the 2Net® and CN5®. This connection is important when the system 10 is used in those remote locations 20 that lack a conventional internet connection, such as the cable/DSL modem 97 with Wi-Fi router 95. It allows the messages sent from a healthcare provider 110, such as the Skylight Data Center in FIG. 3, to be sent to the television 80 as an overlay 90. It further allows for communication of a patient's 30 input via an input device 50, such as the keyboard or remote, to reach the healthcare provider 110. This connection is further useful, for example, when the sensor takes data that is then displayed on the overlay 90 of the television 80 for the patient 30 to view. Many other uses of the direct connection between the 2Net® and CN5® are possible. Those listed here are merely for illustration of some embodiments of the system 10 and are not exhaustive.

Connection to a television 80 by a CN5® accords with the connection type of the television 80. For example, if the television 80 requires an HDMI connection, the CN5® will provide for an HDMI connection, etc. This will typically accord with the connection type of the active television signal 92. For instance, if the television signal is over a component connection to the CN5®, then the CN5® will likewise have a component connection to the television 80, etc.

In some embodiments, the system 10 allows for other devices 82 to be connected to the television 80 and still provide functionality to insert the overlay 90. For example, other devices as shown include an Xbox game console, a DVD/BluRay player, a Playstation console, a Wii console, and/or other devices. In some embodiments, a sensor and multiplexer (not shown) may be implemented to allow the system 10 to recognize the type of device currently being used and to insert the overlay 90 over the active signal being transmitted through that device. For instance, a DVR or other device may be implemented, as discussed in further detail herein, along with an off-the-shelf sensor and multiplexer to allow for recognition of that device on the active signal. Many other devices and implementations with this and similar hardware may be implemented that are known by those with ordinary skill in the art and are within the scope of the present disclosure.

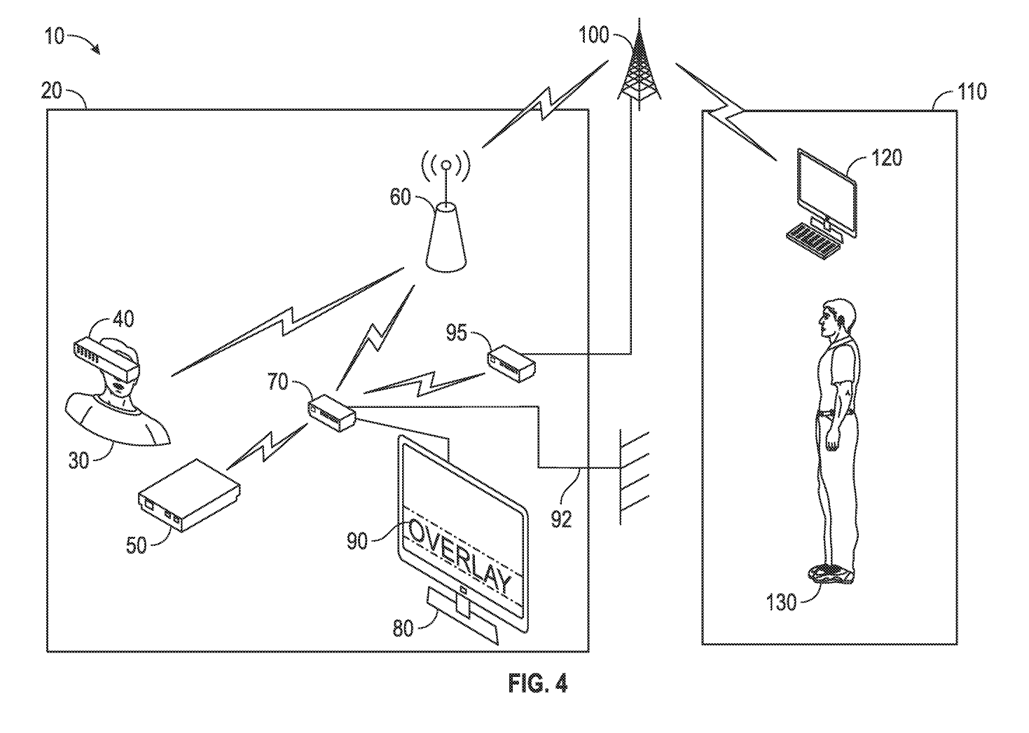

Another embodiment of the system 10 is shown in FIG. 4. In this embodiment, the system 10 does not require a conventional internet connection to a network 100, such as through a cable or DSL modem. Rather, the connectivity to a network 100 is achieved through the portal 60. The sensor 40 and hub 70 both communicate with the network 100 through the portal 60. This arrangement of the system 10 allows for use in remote locations 20 that do not have internet capability, thus broadening the reach of the system 10. As further discussed herein, the portal 60 has multiple connection options creating a flexible system 10 that can be used in any remote location 20 where one of these connection options are available, regardless of whether conventional internet connectivity is available.

A block diagram illustrating an embodiment of a hub 70 is shown in FIG. 5A. The hub 70 contains software and circuitry configured for use with a variety of components and processes. In some embodiments, the hub 70 has an input component 500, overlay mixer control circuit 522, processor 525, working memory 530, storage 535, memory component 540, and output component 570. Various types of input may be received through the input component 500, processed by the mixer control circuit 522, and/or the processor 525 and/or the various modules of memory component 540 in conjunction with the memory components 530 and 535, and output to various devices through the output component 570, as well as displayed on display 537.

The input component 500 of the hub 70 is configured for various types of input connections and signals. It may receive a video signal such as a television signal through the television signal input 505, a user or patient input through the input device input 510, a sensor or medical device input via the portal input 515, or a message or information for overlay on a television through the overlay input 520. The memory component 540 contains various programs that are carried out depending on the desired process to be performed by the hub 70. It may perform pre-programmed analysis or processes using an applications module 545, analyze and process the resolution of a signal using a resolution module 550, analyze and process input signals using the input module 560, and carry out these or other various processes with the operating system 565. The output component 570 comprises capabilities for various types of output connections and signals. It may output a television signal through the television signal output 575, a user or patient output through the input device output 580, a sensor or medical device output via the portal output 585, or a message or information for overlay on a television through the overlay output 590. The working memory 530, storage 535 and/or display 537 may be used in conjunction with these or any of the other processes and actions of the hub 70. As will be discussed below, the hub 70 may have separate inputs that are not grouped within a single input component. For example, in some embodiments, some inputs are sent directly to the overlay mixer control circuit 522 while others are first sent to the processor 525. Therefore, the illustration of a single input component 500 is not meant to preclude these and other embodiments of the hub 70.

As mentioned, an input component 500 comprises capabilities for various types of input connections and signals. The television signal input 505 allows the hub 70 to receive various types of television signals from a variety of connection types. For instance, a cable or satellite television signal may be sent to a receiver as part of a home entertainment system. From the receiver, the hub 70 can receive the television signal through, for instance, an HDMI connection via the television signal input 505. It could also receive this same cable or satellite television signal through a component or composite connection. The television signal input 505 of some embodiments of the hub has the flexibility to adapt to any and all of these three connection types. Other hub embodiments will comprise a television signal input 505 that only recognizes one of either HDMI, component, or composite connection types. Further, devices other than receivers may be used to connect to the television signal input 505, such as cable boxes, streaming television, or other sources.

Another type of input to a hub 70 may be from an input device through the input device input 510. This input allows an input device to communicate with and transmit information or data to the hub 70. In some embodiments, the input device is a Skylight RF keyboard or remote and the input device input 510 is an RF receiver. This allows the RF signal to be sent from the keyboard or remote and received by the hub 70. In other embodiments, the input device input 510 may accommodate any other type of wireless or wired connection, for instance Bluetooth, Wi-Fi, or Ethernet cable.

As further shown in FIG. 5A, the hub 70 may also receive input from a portal through a portal input 515. In some embodiments, the portal sends data to the portal input 515 related to sensor or medical device measurements. For instance, a scale may transmit a signal containing weight information to the portal via a Bluetooth connection, or a healthcare provider may transmit instructions for a television overlay to the portal. The portal may then transmit this signal to the hub 70 through the portal input 515. This transmission of information from the portal to the hub may be through a Wi-Fi connection, in which case the portal input 515 is a Wi-Fi capable receiver. The connection may also be a variety of other wireless or wired types, for instance Bluetooth, RF, or data cable. The corresponding portal input 515 would accommodate the respective connection type, i.e. circuitry and/or software capable of receiving a signal via Bluetooth, RF, or data cable.

Another input capability of the hub 70 as shown in FIG. 5A is an overlay input 520. In some embodiments, an overlay input 520 provides capability to receive data or information relating to an overlay intended to be displayed or otherwise conveyed on a television. The overlay input 520 may be a Wi-Fi enabled receiver to receive data from a healthcare provider through the internet. For instance, a healthcare provider may send a message or inquiry through the internet to a remote location's modem and Wi-Fi router, which then transmits the data to the hub 70 via the overlay input 520. Besides a Wi-Fi signal receiver, the overlay input module 520 may in some embodiments be other wireless or wired connections, for instance Bluetooth, RF, or Ethernet cable. Further, the overlay input 520 may be the same input means as other input components. For example, the overlay input 520 and the portal input 515 may both receive information through the same Wi-Fi receiver. Thus, the same input connection may be used for the various input components in the embodiment of the hub 70 shown in FIG. 5A. This capability is possible even though the input component 500 is shown containing several different input types. This is merely for illustration and discussion of the various input types and does not preclude combination of any or all of the input types in a single input.

Once a signal has been received through the input component 500, in some embodiments it may be sent to a processor 525 for processing and analysis of the input signal. Depending on the content of the input signal, a number of actions are possible. In some embodiments, the processor 525 will run one of several modules contained in memory component 540. An applications module 545 may run a variety of applications that relate to patient interaction, gathering data, or reporting back to a healthcare provider or central database. For example, if a portal receives a measurement from a medical device, the data may be sent to the hub 70 and then processed by an application in the applications module 545. This is just one embodiment of the applications module and many other uses are possible. Further, these applications may be pre-programmed with the hub 70 or added or updated later once the hub 70 has been deployed to a remote location.

In other embodiments, an input signal may be sent to the overlay mixer control circuit 522. For instance, an input video signal such as a television signal may be received by the television signal input 505 and then be sent to the overlay mixer 522. An overlay mixer 522 may receive the signal through an HDMI, composite, or component video input connection and then feed the signal to the output component 570. The overlay mixer 522 may also receive another input signal from the video output of the processor 525 which will produce images or messages to be overlaid to the main video stream which is active at that time. Further details of the hub process for producing an overlay message are discussed below, for example with respect to FIGS. 5B and 5C.

The resolution of the television and overlay signals is processed by the resolution module 550. This module ensures that the resolution is preserved for a given signal on a given television and that the overlay resolution is adjusted accordingly to match the input signal. For instance, if a high-definition television is used with an HDMI connection, then the resolution module 550 will process the signal so that the same quality television signal and overlay are transmitted and displayed on the television screen. Other levels of definition are possible and this is only given as one example to illustrate the functionality of this module.

The input and output signals to the hub 70 are handled by, respectively, the input module 555 and the output module 560. These modules process data related to either the input or output. For example, in some embodiments, the input signal may be received through an overlay input 520, analyzed by the processor 525 and identified as an input, and then processed by the input module 555. Similarly, an output signal may be processed by the output module 560 and then sent to the processor 525 for output. The output signals are output via the output component 570.

An embodiment of an output component 570 as shown in FIG. 5A contains a number of output connections types, as mentioned above. In some embodiments, a television signal output 575 allows for output of a television signal from a hub 70 to a television. This output allows the hub 70 to operate on the active television signal. It is this capability that allows the system to display an overlay while a user or patient is watching television, whether live or recorded, as long as it is on the active television input. This television signal output 575 may be any or all of HDMI, composite, or component connections. In some embodiments, all three connection types are included in the television signal output 575. In other embodiments, only a single connection type is included. For instance, one embodiment of a hub 70 may allow for output only over an HDMI connection, another embodiment may allow for output only over a composite connection and another embodiment may allow for output only over a component connection. The television signal output 575 allows for the proper type of signal and connection to be accommodated by the hub 70.

Another output feature of the hub 70 is an input device output 580. The input device output 580 allows for output of data and information from the hub 70 to an input device. In some embodiments, the connection is over RF, however it may be over any type of wireless or wired connection, such as Bluetooth, Wi-FI, or Ethernet cable. In some embodiments of the hub 70, the input device output 580 is capable of accommodating any or all of these connection types. In other embodiments, the input device output 580 is configured for a single connection type, such as RF. Many combinations of capabilities are possible in this regard. In some embodiments the input device is a keyboard or remote that a patient may use to communicate with the hub 70. Further, the input device can also receive information from the hub 70. For example, in some embodiments, the input device is also an awareness beacon or message alert system that alerts a patient to an overlay message on the television. In some implementations, an alert is sent to the hub and then output through the input device output 580 to the input device, which then alerts the patient in any of a variety of ways, for instance by beeping or flashing.

The hub 70 can likewise communicate to a portal through a portal output 585. The portal output 585 allows for communication to the portal by a variety of means. In some embodiments, the portal output 585 sends data or information to the portal by Wi-Fi. Other types of wireless or wired connections may be implemented, for instance RF, Bluetooth, or Ethernet cable. The portal output 585 is used in a variety of contexts. For example, an input device may be used to send a signal to the hub 70 for a sensor to take a measurement. The hub 70 would receive this signal via the input device input 510. Next, the processor 525 would analyze and accordingly process the signal, configured by, for example, an application in the applications module 545 in conjunction with the operating system 565. Then the signal is sent to the portal output 585 for transmission to a portal, which would then communicate with the appropriate sensor or medical device to take the indicated measurement. This is merely one example of the capability of the portal output 585. This example is given merely to illustrate an embodiment of the component. Many other capabilities may be implemented.

The overlay output 590 is another component of the output component 570 in an embodiment of the hub 70. The overlay output 590 processes and transmits the signals to be displayed as an overlay on a television. It is this capability that allows the system to display an overlay while a user or patient is watching television, whether live or recorded, as long as it is on the active television input. The overlay output 575 may be any or all of HDMI, composite, or component connections. In some embodiments, all three connection types are included in the overlay output 575. In other embodiments, only a single connection type is included. For instance, one embodiment of a hub 70 may allow for output only over an HDMI connection, another embodiment may allow for output only over a composite connection and another embodiment may allow for output only over a component connection. The overlay output 575 allows for the proper type of signal and connection to be accommodated by the hub 70.

In some embodiments, grouped components may be ungrouped, grouped differently, or exist as individual components. For instance, the television signal output 575 and overlay output 590 may be combined to form a single output. The illustration of separate outputs is not meant to preclude an embodiment where the two are combined. In some embodiments, the television signal output 575 and overlay output 590 are combined or mixed by the overlay mixer 522 and then output to a television. In some embodiments, the various inputs of input component 500 and/or output component 570 are, in whole or in part, individual inputs. Further detail of these and other embodiments are discussed below, for example with respect to FIG. 5B.

Memory components are also shown in the hub 70 embodied in FIG. 5A. A working memory 530 may be used for short term or random access while carrying out different processes. For example, the operating system 565 or processor 525 may need working memory 530 while analyzing and processing an input signal and preparing it for output. The storage 535 may also be used for actions requiring longer term memory storage. For instance, some data sent for an overlay from a healthcare provider may be so large or frequently used that it stores it in the storage 535 for retrieval at appropriate times. These are just some of the possible uses of the memory components as embodied in the hub 70 of FIG. 5A. Other uses and capabilities in conjunction with these and other components may be implemented and are not explicitly mentioned here. It is understood that discussion of some of the implementations does not limit the scope of the disclosed systems and methods.

The operating system module 565 configures the processor 525 to manage the memory and processing resources of the hub 70. For example, operating system module 565 may include device drivers to manage hardware resources such as display 537, storage 535, or television signal input 505. Therefore, in some embodiments, instructions contained in the applications module discussed above may not interact with these hardware resources directly, but instead interact through standard subroutines or APIs located in operating system component 565. Instructions within operating system 565 may then interact directly with these hardware components.

Processor 525 may write data to storage module 535. While storage module 535 is represented graphically as a traditional disk device, those with skill in the art would understand multiple embodiments could include either a disk based storage device or one of several other type storage mediums to include a memory disk, USB drive, flash drive, remotely connected storage medium, virtual disk driver, or the like.

Although FIG. 5A depicts a hub 70 comprising separate components, for instance a processor 525 separate from the memory components 530 and 535, one skilled in the art would recognize that these separate components may be combined in a variety of ways to achieve particular design objectives. For example, in an alternative embodiment, the memory components may be combined with processor components to save cost and improve performance.

Additionally, although FIG. 5A illustrates two memory components, memory component 540 and a separate memory 530 comprising a working memory, one with skill in the art would recognize several embodiments utilizing different memory architectures. For example, a design may utilize ROM or static RAM memory for the storage of processor instructions implementing the modules contained in memory component 540. Alternatively, processor instructions may be read at system startup from a disk storage device that is integrated into the hub 70 or connected via an external device port. The processor instructions may then be loaded into RAM to facilitate execution by the processor. For example, working memory 530 may be a RAM memory, with instructions loaded into working memory 530 before execution by the processor 525.

The various steps and processes of the hub and the overall system may be implemented in a number of different implementations with intermediate steps. The overall process 200 discussed herein is an overview of the various steps that the system is capable of performing. Some of these individual steps may comprise intermediate steps and processes, as is further discussed in detail with respect to other figures of the disclosure. Also, as further discussed herein, the use of any one embodiment of a part of the illustrated systems and methods of this disclosure is not meant to limit the disclosure to only those embodiments. For example, a wireless internet connection may have a number of different embodiments, including Wi-Fi or even wired connections such as Ethernet cable, and the use of a “healthcare provider” in a given embodiment may likewise take a number of different embodiments, including a data center or parent. These are merely given here to illustrate certain examples of the present disclosure.

FIG. 5B is a block diagram illustrating another embodiment of a hub 70.

In some embodiments, the overlay mixer 522 receives a video input 505, in either HDMI, composite (CUBS), and/or component (Y—Pb—Br converted to digital). The overlay mixer 522 feeds the same to an output 570. Another input is brought to the overlay mixer 522 from a video output of a processor which may be a control ARM CPU core processor 525. The ARM core 525 receives signals for overlays and produces the images or messages to be overlaid on a main video stream input 505, such as a television signal, that is active at the time. The ARM core 525 will run an application program that gets some info from the special environment's I/O 520 and allows for info to be overlaid to the current main video signal input 505. In some embodiments the ARM core 525 has medium-end graphic capabilities and can manage various features, such as streaming videos from the internet or from onboard memory, manage video conference calls, do local video playback, etc. The overlay mixer 522 will combine the input 520 for message overlay with the video input 505 and output the overlaid signal through a corresponding connection type output 570, which may be an HDMI signal, or a converted digital to analog composite or component signal.

FIG. 5C is a block diagram illustrating another embodiment of a hub 70 with sample images. In some embodiments, the overlay mixer 522 is built around a field-programmable gate array (FPGA) such as a high-end Xilinx Spartan FPGA, and the processor 525 is a Freescale iMX535 Core processor. The FPGA 522 can detect the input resolution from a video input 505, such as HDMI or others, for example 480p, 720p, 1080i, 1080p and 3D. The FPGA 522 will communicate this information to the ARM processor 525 such that the processor can prepare its video interface to have the same resolution as the main video input 505. In the embodiment shown, the input 505 is from a television signal 92 showing a trio of penguins.

In some embodiments, the overlay image or message sent to the input 520 to be overlaid is processed by the ARM processor 525 such that a uniform background 93 is produced with the overlay. The FPGA will adjust the background 93 and combine the image or message 90 with the input television signal 92. As shown in FIG. 5C, an overlay 90 comprising text and image data is sent to the input 520. The data includes the text “TEXT 1,” “TEXT2,” and “TEXT3,” and the image data is for an image of an alarm clock. The Arm processor 525 processes this input overlay 90 and produces the overlay 90, shown for clarity in FIG. 5C inside the FPGA, with a uniform background 93. This image is received by the FPGA 522, which may adjust this background 93 to be completely transparent, such that the text and alarm clock image are visible over the signal 92 comprising the trio of penguins. This image is then sent to the output 570, which may be HDMI, and is displayed on a television 80 with the overlay 90 as shown.

In some embodiments, the transparency of the background 93 can be set into an FPGA 522 register by the ARM processor 525. The percentage of transparency may be handled by a control register. In some embodiments, the control register is 8 bits, and the value may be from 0%, meaning nothing is overlaid, to 100% which means everything is overlaid. The communication between the FPGA 522 and the ARM processor 525 can be managed with an SPI or an i2C channel, with the FPGA 522 to be slave only while the ARM processor 525 is the master. After the power-on/boot cycle of the hub 70 and after the FPGA 522 has been configured or programmed, the interface will start to work. The FPGA 522 will correct or synchronize the frames between the main video input 505 and the image or message overlay 90 that is output from the ARM processor 525. To do this, the FPGA 522 will buffer one or two video frames, which are output from an ARM microprocessor, in an external memory such as random access memory (RAM) or working memory 530, and at the same time the FPGA 522 will also read out the overlaid video from the frame buffer (RAM) by following the main video timing. The ARM processor 525 can output the overlay 90 image and/or message at any frame rate, and the FPGA 522 only needs to know the resolution. In some embodiments, the frame rate output by the ARM processor 525 is not slower than the frame rate of the input television signal 92, but it may be as close to the lowest rate possible in order to save FPGA RAM bandwidth.

In some embodiments, the FPGA 522 will receive an input television signal 92 through input 505 and will recognize the resolution of the signal 92. The FPGA 522 will then make the input resolution known to the ARM processor 525 through a register. The ARM processor 525 will then adjust its own video resolution to the same resolution as the input signal 92 received through input 505. From here, the ARM processor 525 can command the FPGA to “get my video output and overlay to current video input” or to “stop overlay.” An application, for example in an applications module 545, may manage the layout of the overlaid image or message. If there is a need to completely hide the underlying signal 92, then the FPGA 522 will be commanded to activate no transparency. If there is the need to preserve the underlying signal 92, then a command such as “manage transparency, key color=[color], transparency=xx %” may be sent to the FPGA 522. Thus, in some embodiments, the overlaid image, message, or video 90 will be displayed, with the FPGA 522 letting the underlying input signal 92 appear where the [color] background is. As a result, an image with overlay, such as the image of the trio of penguins with the text and alarm clock overlay 90, may be displayed on the television 80, as further shown in FIG. 5C.

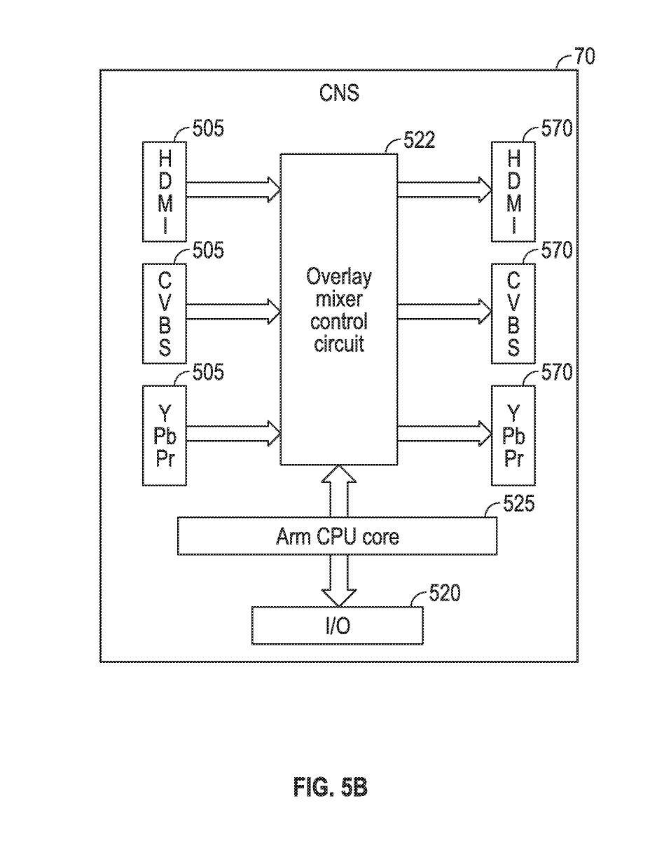

In method 200, step 215 involves the transfer to an intermediate device of measurements taken by a sensor. This step is further detailed in the two embodiments shown in FIGS. 6A and 6B. One embodiment, as shown in FIG. 6A, begins with the sensor taking a measurement in step 605. Next, the sensor transmits this measurement or data to a portal in step 610. The process then moves to step 615 where the portal transmits the data to a hub. Thus the data may flow from the sensor to the portal to the hub. However, it is also understood that some embodiments of the processes and systems of the present disclosure may be portions of the embodiments discussed. For example, another embodiment of step 215 may comprise only a portion of the embodiment shown in FIG. 6A, in that step 215 may only consist of steps 605 and 610, where a sensor takes measurements and transmits them to the portal, without the need for step 615, where the portal transmits the data to the hub. Therefore, some embodiments not explicitly addressed may still exist and may be portions of the embodiments explicitly discussed.

In another embodiment of step 215, as shown in FIG. 6B, the sensor takes a measurement as shown by step 630. In the next step 635, the sensor transmits the data to the portal. Then, the portal transmits this data to an off-site data center in step 640. Finally, in step 645, the data center transmits this data to the hub. FIGS. 6A and 6B are merely two embodiments of the possible processes that may be followed in order for sensor measurements to be transmitted to a hub or portal or other intermediate device. Other embodiments of this step 215 are possible that are consistent with features of system 10 disclosed herein. These are given here as illustrations of possible embodiments of this process and are not meant to limit the scope of the present disclosure.

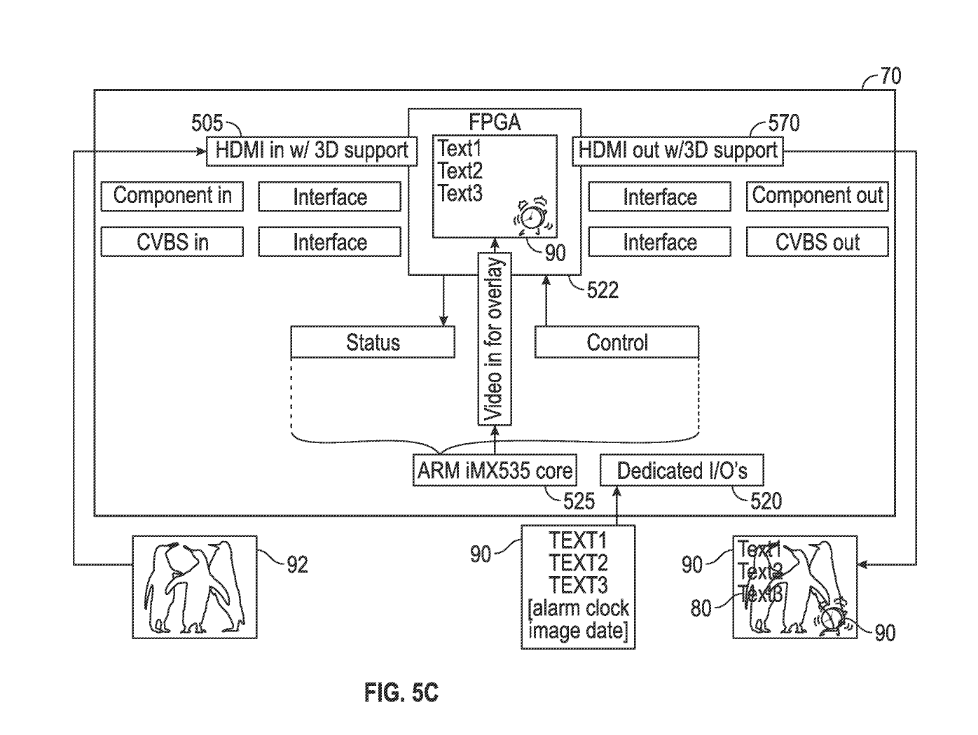

As shown in FIGS. 7A and 7B, step 220 may take a number of different embodiments. Step 220 involves the transfer of data from an intermediate device to a healthcare provider. In one embodiment of this process, as shown by FIG. 7A, a portal first receives data in step 705. Next, in step 710, the portal transmits this data to a healthcare provider. In another embodiment, depicted in FIG. 7B, step 220 first involves a hub transmitting data to a wireless internet connection as shown in step 720. This wireless internet connection then transmits the data to the healthcare provider in step 725. Other embodiments of data transfer to a healthcare provider may be implemented. These are merely two examples given to illustrate the embodiments of step 220 and are not meant to limit the scope of the present disclosure.

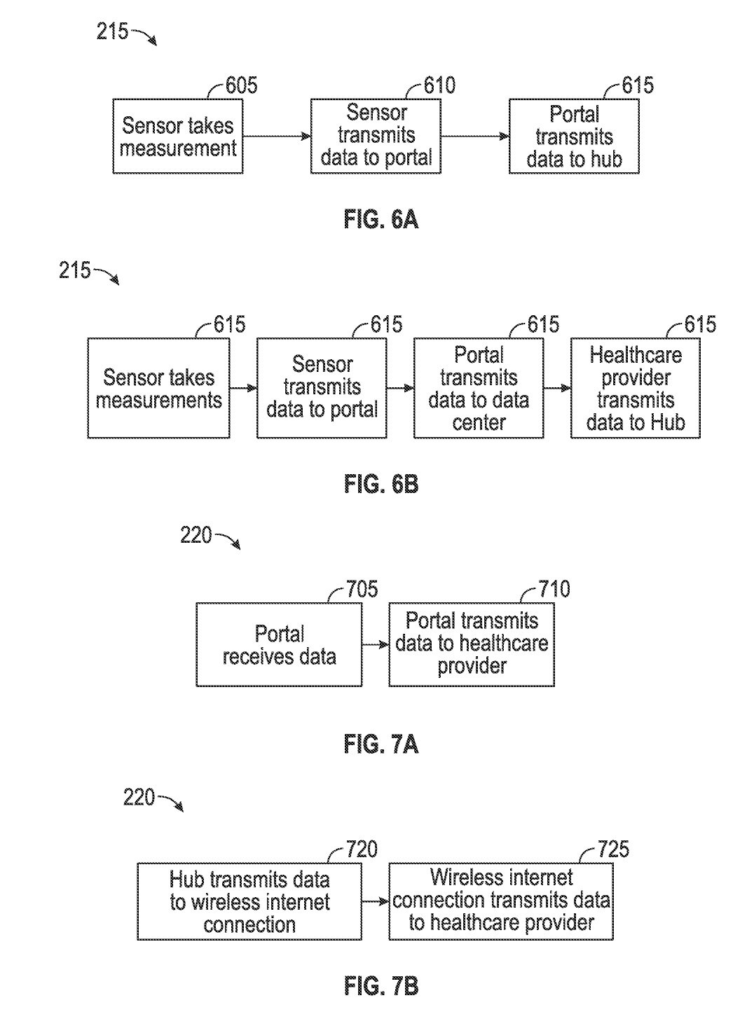

Sending instructions from an off-site location to a remote location for a sensor to take measurements may also take a number of forms. Step 230 involves a healthcare provider sending instructions to a remote location for a sensor to take measurements. In one embodiment of this process, as shown in FIG. 8A, it begins with step 805 where a healthcare provider sends instructions to a portal. The process then moves to step 810 where the portal transmits the instructions to the sensor. Then, in step 815, the sensor takes the measurements. Another embodiment of step 230 is shown in FIG. 8B. This embodiment begins with step 830 where a healthcare provider sends instructions to a hub. Next, in step 835, the hub transmits the instructions to the portal. The portal then in step 840 transmits the instructions to the sensor, which, in step 845, takes the measurements. Therefore, a number of intermediate step may occur in step 230 in order for a healthcare provider's instructions for a sensor to take measurements to be carried out.

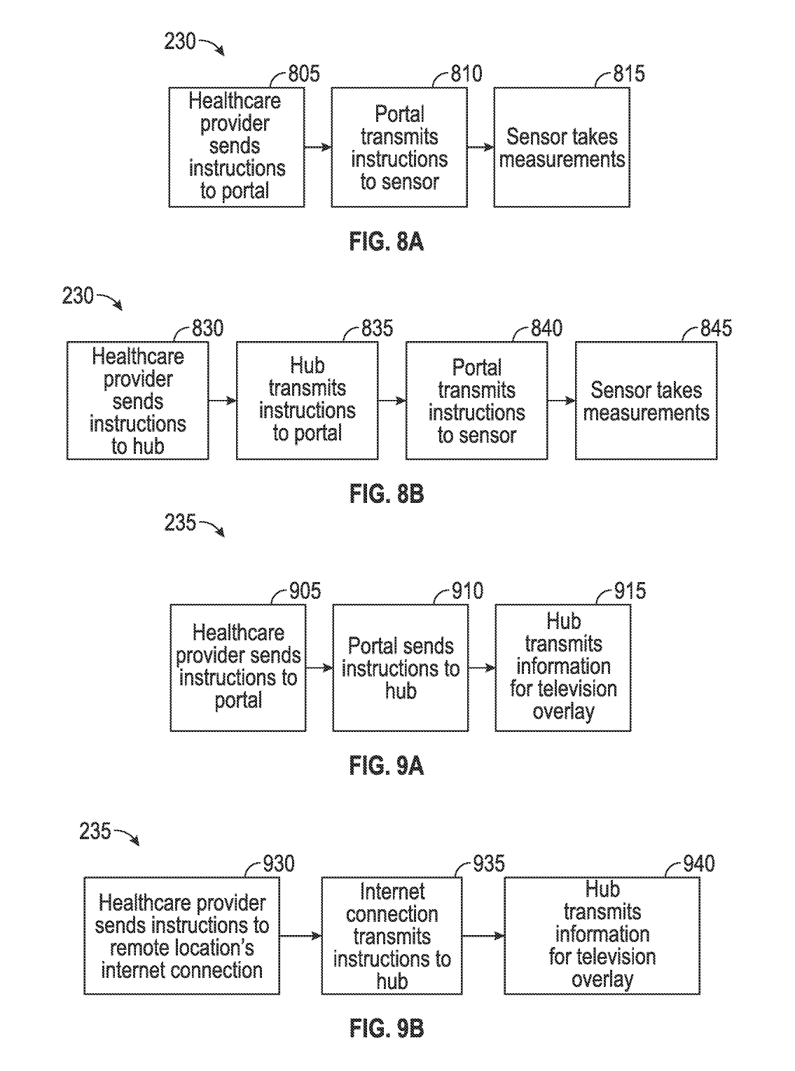

A number of embodiments also exist for step 235 which involves a healthcare provider sending data for a television overlay. FIG. 9A depicts one such embodiment, where the healthcare provider in step 905 sends instructions related to an overlay to a portal. Next, in step 910, the portal sends these instructions to a hub. Then the hub transmits this information to a television for overlay on the television display in step 915. Another embodiment of a healthcare provider sending data for a television overlay is shown in FIG. 9B. Here, a healthcare provider sends instructions to the internet connection of a remote location in step 930. Next, in step 935, the internet connection transmits the instructions to a hub. Then in step 915 the hub transmits this information to a television for overlay. The connections between the various devices that are used for sending the data, including the internet connections, may take a number of forms and should not be limited by the concrete example given herein with respect to any one embodiment. For instance, the internet connection in the FIG. 9B embodiment may be a wireless internet connection whereby the healthcare provider sends data to the remote location's cable or DSL modem, which transmits it to a Wi-Fi router, which sends it to the hub. Other devices and processes are capable of integration and implementation with the current disclosure and are understood to be within the scope of the disclosure.

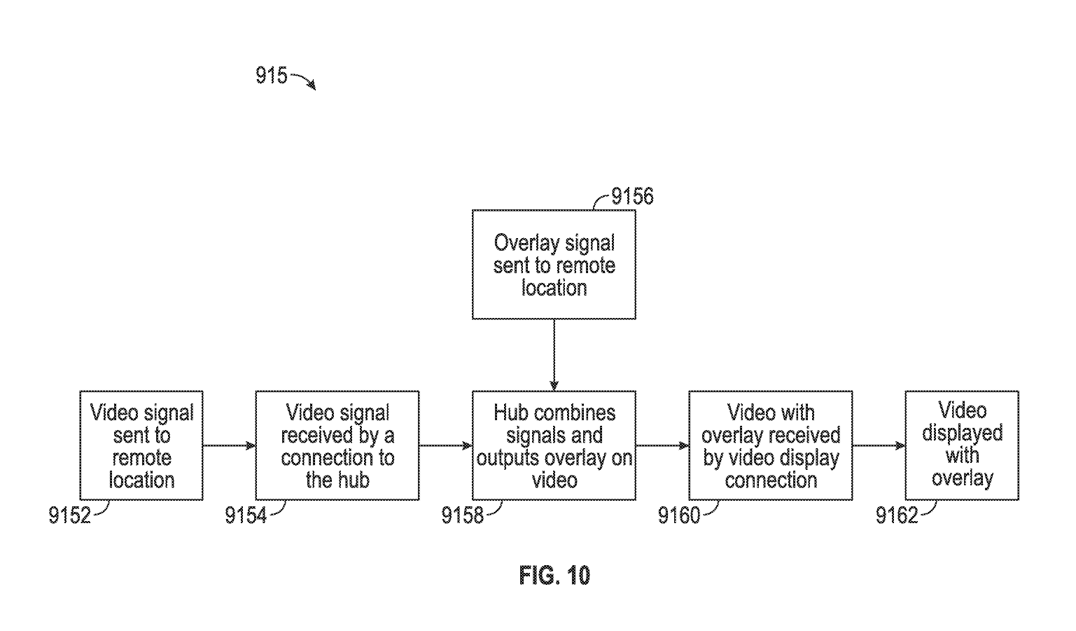

FIG. 10 is a flow chart depicting an embodiment of step 915 whereby a hub transmits a television signal with an overlay. As shown, step 915 may begin with substep 9152 whereby a video signal such as a television signal 92 is sent to the remote location. This television signal 92 may be received from a variety of sources and may be live or recorded. For instance, the signal may be a current signal received through a cable box or it may be a recorded program being watched through a DVR machine. Next, in substep 9154, the signal is sent to and received by an input connection to the hub. The input connection may be an HDMI connection, a component connection, or a composite connection. The connection is next received by a hub 70 in substep 9158, which in some embodiments is a CN5® device. The CN5® receives the television signal 92 through the input connection. In concurrent step 9156, the CN5® also receives overlay instructions to be overlaid onto a television. Next, the CN5® transmits the signal 92, with the overlay, through an output connection that is received by a complementary video display connection. The output connection on the CN5® may be an HDMI connection, a component connection, or a composite connection. In some embodiments, the output connection type matches the input connection type. For example, both the input and output connection types may be HDMI, etc. Finally, in substep 9162, the television signal 92 with the overlay is sent through the connection to the television and is displayed or otherwise conveyed by the television.

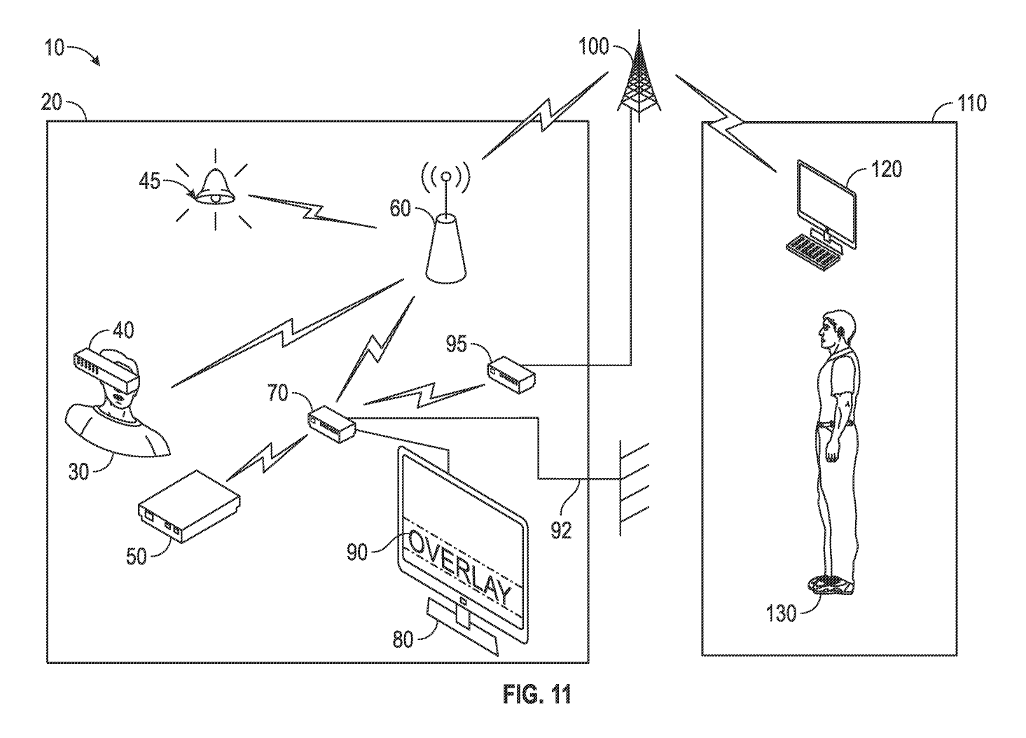

An overlay sent to a television may not always be perceived or noticed by a patient or user. Thus, as mentioned, some embodiments of the system 10 include an awareness beacon 45. The beacon 45 alerts the patient 30 or user to an overlay 90 that has been sent to the television 80. As mentioned, the awareness beacon 45 could be the sensor 40 itself. In other embodiments, the awareness beacon 45 is a separate device. An embodiment of an awareness beacon 45 is shown in FIG. 11. As depicted, the awareness beacon 45 is in wireless communication with the portal 60. The wireless communication could be Wi-Fi, RF, or any other number of wireless data transmission connections. The beacon 45 could also be hard-wired to the portal 60. Further, the beacon may, instead of or in addition to a portal 60, be in communication with a hub 70. Any of the data transmission techniques described herein with respect to other components of system 10 may likewise be used to communicate and connect with a beacon 45. Further, the input device 50 may be used to control a beacon 45, such as hitting snooze if an alarm on the beacon goes off, or turning the alarm off altogether. The beacon 45 in some embodiments will create an auditory alert, such as a beeping alarm, for the patient 30. In other embodiments, the beacon 45 will create a visual alert, such as a flashing light. In additional embodiments, the beacon 45 will have a combination of auditory and visual alerts. These are just some of the features and forms of an awareness beacon 45, and many other embodiments will be readily apparent to those skilled in the art. For example, the beacon 45 may also vibrate, or it may be a cell phone, etc. The discussion of some embodiments of the beacon 45 herein is not meant to limit the scope of the disclosure or preclude other embodiments not explicitly addressed or mentioned.

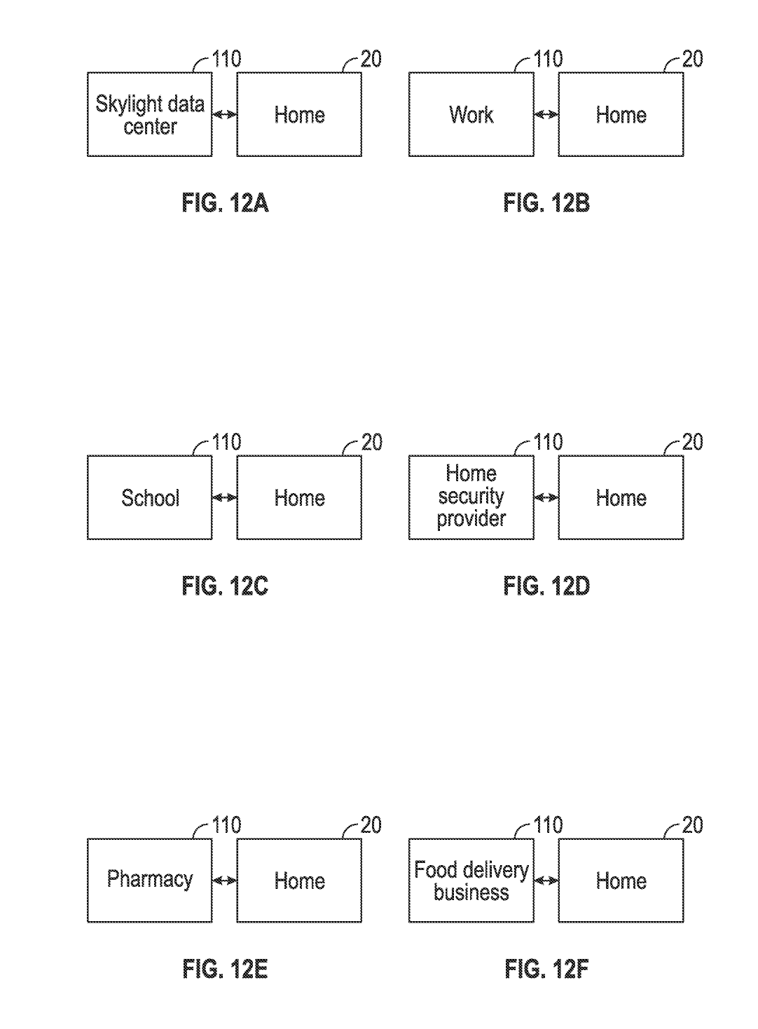

While the healthcare context is one setting in which the disclosed communications system and methods may be used, it may be implemented in other embodiments as well. FIGS. 12A-F show some of the many embodiments for the healthcare provider 110 and the remote location 20 in which the disclosed systems and methods may be embodied. For instance, FIG. 12A depicts the use of the system and methods where the healthcare provider 110 is a Skylight Data Center and the remote location 20 is a home. In this embodiment, the data center may act similarly to a healthcare provider in that it has healthcare professionals or decision-makers who receive and send instructions to a health patient at home. The data center may also be a repository of the information being sent over the system that will be used for later data mining and research. These are just some of the implementations of the system embodied in FIG. 12A, and many others not mentioned here may be implemented.

Another embodiment of the system 10 is shown in FIG. 12B. In this embodiment, the healthcare provider 110 is a place of work or business and the remote location 20 is the home. One implementation of this embodiment is the use of the system and methods by a parent at work communicating with a child at home. For example, the parent from work may want to send a message to his or her child at home reminding the child to take out the trash or letting the child know when the parent will be home from work.

An additional embodiment of system 10, depicted in FIG. 12C, is that of the school communicating with the home. In an implementation, a school may want to communicate with a student's parents at home. For example, a school administrator may communicate to the parents at home that a student was absent from school, or to give a progress report on the student.

Another embodiment of the system 10 may involve a home security provider and the home, as shown in FIG. 12D. In an implementation, a home security provider may be a security company hired to keep a watch on the home premises and to monitor various alarms of the home. The provider may want to communicate with occupants of the home while they watch television. For instance, the security provider may want to communicate that a back door alarm has been tripped.

In some embodiments of the system 10, the healthcare provider 110 is a pharmacy and the remote location 20 is the home, as illustrated in FIG. 12E. In an implementation, the pharmacy may want to communicate with a patient at home regarding their prescription. For instance, the pharmacy may send an overlay to the home letting the patient know that the prescription is or will be ready.

FIG. 12F shows another embodiment of system 10 where a food delivery business communicates with a home. In an implementation, a home delivery business is a pizza delivery that wants to communicate with a family that ordered pizza. For example, the pizza delivery company may send a message to the family that the pizza will be delivered in five minutes.

In any of the embodiments given in FIGS. 12A-F, the communication may be bi-directional. For instance, the home may respond back to the data center, to work, to the school, to a security provider, to a pharmacy, or to a delivery company. Further, any of the features of the system 10 and method 200 discussed herein are applicable to the embodiments and implementations of FIG. 12A-F. For example, the home security provider may send an alert to an awareness beacon, or a pharmacy may send an inquiry requiring response, or a parent at work may ask a child at home to use one of the sensors implemented in that embodiment, such as a camera to take an image of a room to verify it has been cleaned. Therefore, any of the discussions of system 10 and method 200 herein apply equally to any of the embodiments discussed in this disclosure, even if not explicitly addressed with respect to those other embodiments.

The overlay displayed on a television by the systems and methods disclosed herein may take a number of different forms. Some overlay embodiments are shown in FIGS. 13A-F. FIG. 13A depicts an embodiment of an overlay asking for a response to the inquiry “Have you taken your medication?” In an implementation, this overlay may be from a doctor monitoring a patient. An overlay may also be used for reporting by a patient. FIG. 13B shows an embodiment of an inquiry “What is your pain level today?” This may be implemented by a doctor who implanted a hip replacement in a patient. Feedback on the durability of the hip replacement and on the patient's comfort level, for example, may be more easily and efficiently tracked with the systems and methods disclosed herein. This in turn improves the quality of future medical devices by allowing for more historical data on past uses. Another embodiment of the overlay may not require a response, such as the overlay depicted in FIG. 13C that says “Appointment Reminder: Dr. Smith, Tues. 3 PM.” In some implementations, this overlay may be from a doctor's office as a courtesy. Other overlay embodiments in other contexts and settings are further depicted in FIGS. 13D-F. These are just some of the embodiments and implementations for which the disclosed systems and methods may be used. The overlays may further be accompanied by sound, may take up larger portions of the television screens, and have any of a number of other formats and characteristics. The examples given are merely intended to illustrate some of the possible embodiments and do not limit the scope of the current disclosure.

FIG. 14 illustrates embodiments of input images used to produce an overlay message on a television 80. Television signal 92 is shown at the top, with a depiction of a character in a movie scene. An overlay message 90 is shown in the middle image, which includes three areas of text and a robot image. The rest of the overlay message 90 is of uniform background, indicated by area 93. When the overlay message 90 is overlaid onto the television signal 92, the uniform background 93 may be made entirely transparent, such that only the overlay 90 texts and image are visible on top of the television signal 92. As a result, the scene with the movie character is visible on the television 80, except for the areas covered by the overlay 90 texts and robot image, as shown in the bottom image of FIG. 14.

An embodiment of an input device 50 is shown in FIG. 15. The input device 50 depicted is a keyboard from Skylight® Healthcare Systems. The keyboard includes many standard computer keyboard keys, as well as other controls for inputting data to the system 10. For instance, video controls may be included which allow a patient to control a video that has been overlaid on their television. In some embodiments, the input device 50 is a keyboard manufactured by TG3 Electronics®, which may be a custom keyboard including a variety of controls and configurations, for example custom medical keyboards and control panels. These may incorporate a variety of features, including custom plastics, metal, rubber, custom or standard protocols, custom firmware/software, splash-proof seals, backlighting for low light environments, backlighting control, full/limited travel, low profile, and flat panel/metal dome switches, Optical Rotary Encoders Linear slide-pots, integrated pointing devices for cursor control including touch pads, track balls and more, LED and LCD Displays, USB interface for all integrated devices, and custom molded keys and bezels.

While the devices, systems and methods disclosed herein have been presented in certain contexts, they may be used in many other contexts as well and in a variety of manners. For instance, the devices, systems and methods, such as the system 10 and/or the method 200, may be used in selectively-accepted “communities” by the user. These different communities may be networks associated with particular friends, hobbies, groups, etc. In some embodiments, users may select to accept the overlay messages 90 from one or more such communities using the input device 50 to communicate with the hub 70 to choose to join the community. In some embodiments, the healthcare provider 110 may be an organizer of one of these communities, whether related to healthcare or other topics, such as hobbies, sports, interest groups, music, etc. The patients 30 may be the users who join this group using the hub 70. For example, the patients 30 may be users who may accept to be included within the community. The community may be a network of friends or those with similar interests who may then communicate with each other using the devices, systems and methods herein, such as the system 10 and/or the method 200. The users may later decide to stop accepting such messages by sending an overlay message 90 to the organizer, or other person or entity responsible for hosting the community or network, with the input device 50 via the hub 70. Therefore, users may decide to connect or disconnect from such communities. The portal 60 may provide the connectivity with the internet or other network to facilitate such uses of the system 10.

In some embodiments, the patient 30 may be a first user who may message another patient 30 who is a second user to send messages, such as the overlay 90, through the hub 70 to the first user's television 80. In some embodiments, a user may use a Skylight® television application, produced by Skylight and look for other services that the user could “sign up” for. For instance, the patient 30 may be a user who signs up for such services by responding or otherwise sending an acceptance message through the hub 70 using the input device 50. In this manner, an entire SL network or community of service providers (e.g. pharmacies, DME companies, grocery stores, medical services, family, friends, support groups, community services, transportation services, etc.) can be created where the different users/subscribers could join the SL network via the Skylight® app. In some embodiments, a data center, such as the data center 110 or 112, may be an organizer or repository that stores, analyzes, updates or otherwise controls the various aspects such as membership o the network or community. In some embodiments, users, such as healthcare patients or others, may selectively subscribe to one or more desired communities and be reminded or otherwise made aware of events, notifications, alerts, a message of the day, a message that the user's pizza is on the way, etc. For example, the patients 30 may subscribe by using conventional messaging means or by using the input device 50 to send a subscription acceptance as an overlay message 90. Then, the community, network service etc. may communicate with the user by sending an overlay message 90 to the user's television 80, for example via the portal 60 and the hub 70 using the methods described herein, such as the method 200 or others.

The devices, systems and methods may also be linked with other services. For instance, information exchange with other services may be implemented. These may be in addition to another use of the system, such as in the healthcare context. For instance, in some embodiments an overlay message 90 may be sent to a patient 30, such as a user or subscriber, via the hub 70 to a television 80, that says “Rick, we know you have an upcoming appointment next Wednesday, would you like to have a transportation service pick you up and take you back home afterwards?” Or, as another example, the message 90 may say “Rick, we see you have subscribed to the San Diego Sailing Interest Group, there is a regatta now planned for [insert date here] in Mission Bay.” In some embodiments, if a user wanted to stop receiving information (e.g. if a user is no longer interested in sailing) then the user may end the connectivity relationship for their hub 70 to that service (or person). This may be done with any of the systems and methods described herein, for instance the system 10 and/or the method 200. These are merely some examples and a variety of uses of the devices, systems and methods disclosed herein may be implemented.

Those having skill in the art will further appreciate that the various illustrative logical blocks, modules, circuits, and process steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. One skilled in the art will recognize that a portion, or a part, may comprise something less than, or equal to, a whole.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. An exemplary computer-readable storage medium is coupled to the processor such that the processor can read information from, and write information to, the computer-readable storage medium. In the alternative, the storage medium may be integral to the processor. The processor and the storage medium may reside in an ASIC. The ASIC may reside in a user terminal, camera, or other device. In the alternative, the processor and the storage medium may reside as discrete components in a user terminal, hub, or other device, for example an input device such as a keyboard or remote.

Any headings included herein are for reference and to aid in locating various sections. These headings are not intended to limit the scope of the concepts described with respect thereto. Such concepts may have applicability throughout the entire specification.

The previous description of the disclosed implementations is provided to enable any person skilled in the art to make or use the present disclosure. Various modifications to these implementations will be readily apparent to those skilled in the art, and the generic principles defined herein may be applied to other implementations without departing from the spirit or scope of the disclosure. Thus, the present disclosure is not intended to be limited to the implementations shown herein but is to be accorded the widest scope consistent with the principles and novel features disclosed herein. While the above detailed description has shown, described, and pointed out novel features of the invention as applied to various embodiments, it will be understood that various omissions, substitutions, and changes in the form and details of the system or process illustrated may be made by those skilled in the technology without departing from the spirit of the invention.

1. A method of overlaying an interactive and bidirectional message on a communications signal, the method comprising:
receiving a communications signal via a communications signal input connection of a hub;
transmitting the communications signal to an overlay mixer circuit of the hub;
receiving an overlay signal via an overlay signal input connection of the hub;
processing the overlay signal to produce an overlay message;
transmitting the overlay message to the overlay mixer circuit;
overlaying the overlay message onto the communications signal using the overlay mixer circuit to produce an overlaid communications signal; and
transmitting the overlaid communications signal through a communications signal output connection of the hub.

2. The method of claim 1, further comprising:
detecting with the overlay mixer circuit a resolution of the communications signal; and
matching a resolution of the overlay signal to the resolution of the communications signal.

3. The method of claim 1, further comprising:
processing the overlay signal to produce an overlay message with a uniform background having a level of transparency; and
adjusting the level of transparency of the uniform background in the overlay message.

4. The method of claim 1, further comprising:
receiving the communications signal from a first source and the overlay signal from a second source; and
transmitting the overlaid communications signal from the hub to a television for display of the overlaid communications signal.

5. The method of claim 4, further comprising:
receiving data from at least one of an input device or portal; and
transmitting the data from the hub to the second source, wherein the second source is remotely located.

6. The method of claim 5, further comprising analyzing the data transmitted to the second source.

7. The method of claim 6, further comprising transmitting a second overlay signal to an overlay signal input connection of the hub.

8. The method of claim 1, wherein the overlaid communications signal comprises an inquiry to which a patient may respond.

9. The method of claim 1, wherein the overlaid communications signal comprises instructions for a patient to take a measurement with a medical device.

10. The method of claim 4, wherein the first source is a television signal provider and the second source is a healthcare provider.

11. The method of claim 1, further comprising:
receiving a communications signal comprising frames of a first video;
receiving an overlay signal comprising frames of a second video; and
synchronizing the first and second video frames.

12. The method of claim 11, further comprising:
buffering at least one of the second video frames in an external memory; and
reading out the overlaid communications signal from the buffering by following a timing of the first video.

13. A system for bidirectional and interactive communication between a remote location and a data center over an active communications signal, the system comprising:
a hub comprising a communications signal input connection, an overlay mixer circuit, a processor, an overlay signal input connection, and a communications signal output connection;
a network connector comprising a transceiver and configured to transmit and receive data to and from the hub; and
an input device configured to communicate with the hub;
wherein the hub is configured to receive a communications signal via the communications signal input connection,
wherein the hub is further configured to transmit the communications signal to the overlay mixer circuit,
wherein the hub is further configured to receive an overlay signal via the overlay signal input connection,
wherein the hub is further configured to process the overlay signal to produce an overlay message and transmit the overlay message to the overlay mixer circuit,
wherein the hub is further configured to overlay the overlay message onto the communications signal with the overlay mixer circuit to produce an overlaid communications signal and transmit the overlaid communications signal via the communications signal output connection, and
wherein the network connector is further configured to transmit the data received from the hub to a remote data center and to receive message data from the remote data center and transmit it to the hub.

14. The system of claim 13, wherein the communications signal is a television signal and the output connection is configured to output the overlaid communications signal to a television.

15. The system of claim 13, wherein the overlaid communications signal comprises an inquiry to which a patient may respond with the input device.

16. The system of claim 13, wherein the overlaid communications signal comprises instructions for a patient to take a measurement with a medical device.

17. The system of claim 16, wherein the medical device communicates measurement data to the network connector.

18. The system of claim 13, wherein the overlaid communications signal comprises at least one of text and an image and a video.

19. The system of claim 13, wherein the hub is a CN5® device.

20. The system of claim 13, wherein the input device is a radio frequency keyboard.

21. The system of claim 13, wherein the network connector is a portal.

22. The system of claim 13, wherein the network connector is a modem and wireless router configured to communicate with the hub.

23. A device for bidirectional and interactive communication with one or more data centers over an active communications signal, the device comprising:
a communications signal input connection configured to receive a communications signal;
an overlay signal input connection configured to receive an overlay signal from a first data center;
an overlay mixer circuit configured to receive data related to the communications signal and to the overlay signal and to provide instructions to a processor for performing a method comprising overlaying the overlay signal onto the communications signal to produce an overlaid communication signal;
an overlaid communications signal output connection coupled with the overlay mixer circuit and configured to transmit the overlaid communications signal to a display device;
an input coupled with the processor and configured to receive an input signal from an input device; and
an output component coupled with the processor and configured to transmit data related to the input signal to a second data center.

24. The device of claim 23, further comprising an input component configured to receive information over a network.

25. The device of claim 24, wherein the input component comprises a portal input that is configured to receive information over the network from a portal.

26. The device of claim 24, wherein the information is received over the network from a medical device.

27. The device of claim 23, further comprising a resolution module configured to provide instructions to the processor to perform a method comprising matching a first resolution of the communications signal with a second resolution of the overlay signal.

28. The device of claim 23, wherein the first data center is the second data center.

29. The device of claim 23, wherein the first and second data centers are healthcare providers.

30. The device of claim 23, wherein the communications signal is a television signal and the display device is a television.

31. The device of claim 23, wherein the input device is a remote.

32. The device of claim 30, wherein the remote is a radio frequency keyboard.

33. The system of claim 13, wherein the communications signal comprises a communications signal resolution, wherein the hub is further configured to detect with the overlay mixer circuit the communications signal resolution and to communicate the detected communications signal resolution from the overlay mixer circuit to the processor, wherein the overlay signal comprises an overlay signal resolution, and wherein the hub is further configured to match the overlay signal resolution to the communications signal resolution.

34. The system of claim 13, wherein the hub is further configured to process the overlay signal to produce an overlay message with a background having a level of transparency and to adjust the level of transparency of the background in the overlay message.

35. The system of claim 13, wherein the network connector is further configured to receive data from a sensor and to transmit the data received from the sensor to the remote data center.

36. The system of claim 21, wherein the portal is a 2NET® device.

37. The device of claim 23, wherein the output component is configured to transmit information to a network.

38. The device of claim 37, wherein the output component comprises a portal output that is configured to transmit the information to a portal.

39. The device of claim 25, wherein the portal is a 2NET® device.
